(19) United States
(12) Patent Application Publication
(10) Pub. No.: US 2014/0297409 A1
(43) Pub. Date: Oct. 2, 2014

(54) Student Location Directed Advertising System

(71) Applicants: Jett Wayne Puckett, Rome, GA (US); Lucas Miller Jennings, Rome, GA (US); Joseph Angebrandt, Silver Creek, GA (US)

(72) Inventors: Jett Wayne Puckett, Rome, GA (US); Lucas Miller Jennings, Rome, GA (US); Joseph Angebrandt, Silver Creek, GA (US)

(21) Appl. No.: 14/302,583

(22) Filed: Jun. 12, 2014

Related U.S. Application Data
(63) Continuation-in-part of application No. 13/543,549, filed on Jul. 6, 2012.
(60) Provisional application No. 61/965,476, filed on Jan. 31, 2014.

(51) Int. Cl. G06Q 30/02

(52) U.S. Cl. CPC G06Q 30/0259; G06Q 30/0269
USPC 705/14.53; 705/14.57

(57) ABSTRACT

A student information and directed advertising system which allows users and merchants to utilize appropriate student, school and other data for marketing, safety and other communications.

### CROSS-REFERENCE TO RELATED APPLICATIONS

This patent application is a continuation-in-part of and claims the benefit of the filing date of copending U.S. patent application Ser. No. 13/543,549 entitled “Directed Advertising And Educational Information Systems” filed Jul. 6, 2012 (USPTO Confirmation Number 1576).

This patent application is a nonprovisional application of and claims the benefit of the filing date of copending U.S. provisional patent application numbered 61/965,476 entitled “Directed Advertising And Educational Information System” which was filed Jan. 31, 2014 (USPTO Confirmation Number 9731).

### INCORPORATION BY REFERENCE

This patent application incorporates by reference in its entirety copending U.S. patent application Ser. No. 13/543,549 entitled “Directed Advertising And Educational Information Systems” filed Jul. 6, 2012 (USPTO Confirmation Number 1576).

This patent application incorporates by reference in its entirety copending provisional U.S. patent application No. 61/965,476 entitled “Directed Advertising And Educational Information System” filed Jan. 31, 2014 (USPTO Confirmation Number 9731).

### FIELD OF THE INVENTION

The present invention in its many and varied embodiments relates to a directed advertising system.

### BACKGROUND OF THE INVENTION

Advertisers, schools, students and others are not able to communicate efficiently or effectively with current telecommunications technology. Educators, parents, students, advertisers and other parties have difficulties exchanging information, trouble coordinating with one another and face continuously increasing financial challenges. Current methods for such communications are problematic and insufficient as are current education and school budgets.

### SUMMARY OF THE INVENTION

In an embodiment, a method can be executed on a computer for directed advertising which can have the steps of: providing a computer having a memory, a processing unit adapted to execute program executable code and the computer adapted to run a program executable code of a directed advertising system in which the directed advertising system is adapted to process a data from a student information system; providing to the memory a school selection criterion having a geographic criterion; providing to the memory a school geographic data which is an attribute of a school and the computer running a program executable code of a rule-based logic to determine whether the school geographic data satisfies the school selection criterion, if the school geographic data satisfies the school selection criterion, then the computer executes program executable code identifying the school as a matching school; providing to the memory a plurality of school data of the matching school from the student information system of the matching school and the plurality of school data having a first student data retrieved from the student information system; providing to the memory a first target market criterion and the computer running a program executable code of a rule-based logic to determine whether the first student data satisfies the first target market criterion, if the first student data satisfies the first target market criterion, then the computer executes program executable code identifying the student as a matching target candidate; providing to the memory a second target market criterion; providing a device data of a device of the matching target candidate and the device data having a device location data and the computer running a program executable code of a rule-based logic to determine whether the device location data of the device of the matching target candidate satisfies the second target market criterion, if the device location data satisfies the second target market criterion, then the computer executes program executable code identifying the device as a matching device and the computer running a program executable code of a rule-based logic which identifies a matching device as a candidate device if the matching device is associated with a matching target candidate; providing to the memory an advertising criterion; providing to the memory a second student data from the student information system and the computer running a program executable code of a rule-based logic to determine whether the second student data matches the advertising criterion, if the second student data satisfies the advertising criterion, then the computer executes program executable code identifying the matching device as a target device and the directed advertising system processing an advertising data to electronically communicate to a target device; and the directed advertising system running a program executable code electronically providing the advertising data to the target device.

In an embodiment, the method executed on a computer for directed advertising can further have the step of providing the first student data and the second student data which are the same. In another embodiment, the method executed on a computer for directed advertising can further have the step of providing the first student data and the second student data which are different. In yet another embodiment, the method executed on a computer for directed advertising can further have the step of providing the first student data which is a student name and the second student data which is a student attribute.

In an embodiment, the method executed on a computer for directed advertising can further have an advertising criterion which is a location criterion. In another embodiment, the method executed on a computer for directed advertising can further have an advertising criterion which has a location criterion and a date criterion. In yet another embodiment, the method executed on a computer for directed advertising can further have an advertising criterion which has a location criterion and a time criterion. In an embodiment, the method executed on a computer for directed advertising can further have an advertising criterion which has a location criterion, a date criterion and a time criterion.

In an embodiment, the method executed on a computer for directed advertising can further have a device data which has a location data. In another embodiment, the method executed on a computer for directed advertising can further have a device data which has a device status data.

In an embodiment, the method executed on a computer for directed advertising can further have the step of providing the first target market criterion and the second target market criterion which are the same. In another embodiment, the method executed on a computer for directed advertising can further have the step of providing the first target market criterion and the second target market criterion which are different. In yet another embodiment, the method executed on a computer for directed advertising according to claim can further have the step of providing the first target market criterion which has a location and the second target market criterion which has a student interest.

In an embodiment a directed advertising system can have a computer having a memory, a processing unit adapted to execute program executable code and the computer adapted to run a program executable code of the directed advertising system. The directed advertising system can have a student information system which is adapted to provide a data for processing by the directed advertising system in which the directed advertising system is adapted to process a school selection criterion having a geographic criterion. The student information system can be adapted to provide a school geographic data which is an attribute of a school for processing by the directed advertising system and the directed advertising system can execute a rule-based logic of the program executable code to determine whether the school geographic data satisfies the school selection criterion. Further, the directed advertising system can be adapted to execute program executable code identifying the school as a matching school if the school geographic data satisfies the school selection criterion and the student information system adapted to provide a plurality of school data of the matching school. The plurality of school data having a first student data retrieved from the student information system. The directed advertising system can be adapted to process a first target market criterion, the first target market criterion having a geographic criterion and the directed advertising system can be adapted to execute program executable code identifying the student as a matching target candidate if the first student data satisfies the first target market criterion. The directed advertising system can be adapted to process a second target market criterion in which the second target market criterion having a device location data and the directed advertising system can be adapted to process a device data from a device of the matching target candidate in which the device data having a device location data. The directed advertising system can be adapted to execute program executable code to identify the device as a matching device if the device location satisfies the second target market criterion and the directed advertising system can be adapted to execute program executable code to identify a matching device as a candidate device if the matching device is associated with a matching target candidate. The directed advertising system can be adapted to process an advertising criterion, and the directed advertising system can be adapted to process a second student data. The second student data retrieved from the student information system. The directed advertising system can be adapted to execute program executable code to identifying the matching device as a target device if the second student data matches the advertising criterion. The directed advertising system can be adapted to electronically communicate an advertising data to a target device. The directed advertising system can be adapted to running a program executable code and electronically provide the advertising data to the target device.

In an embodiment, the directed advertising system further is adapted to execute program executable code to identify the device as a matching device if the student data satisfies two or more target market criterion. In another embodiment, the directed advertising system further is adapted to execute program executable code to identify the device as a matching device if a time criterion is satisfied. In yet another embodiment, the directed advertising system further is adapted to execute program executable code to identify the device as a matching device if a student interest criterion is satisfied.

In an embodiment, a computer software product can have a computer executable software code adapted to execute rule-based logic and process data which provides data to a computer memory. The computer executable software code is adapted to be processed at least in part by a processing unit adapted to execute computer program executable code. The computer executable software code is adapted to process a data from a student information system. The computer executable software code is adapted to process a school selection criterion having a geographic criterion. The computer executable software code is adapted to process a school geographic data which is an attribute of a school. The computer executable software code is adapted to execute a program executable code of a rule-based logic to determine whether the school geographic data satisfies the school selection criterion. If the school geographic data satisfies the school selection criterion, then the computer executable software code executes program executable code identifying the school as a matching school. The computer executable software code adapted to process a plurality of school data of the matching school from the student information system of the matching school. The plurality of school data having a first student data retrieved from the student information system. The computer executable software code is adapted to process a first target market criterion. The computer executable software code is adapted to execute a program executable code of a rule-based logic to determine whether the first student data satisfies the first target market criterion. If the first student data satisfies the first target market criterion, then the computer executable software code executes program executable code identifying the student as a matching target candidate. The computer executable software code is adapted to process a second target market criterion. The computer executable software code is adapted to process a device data of a device of the matching target candidate; the device data having a device location data. The computer executable software code adapted to execute a program executable code of a rule-based logic to determine whether the device location data of the device of the matching target candidate satisfies the second target market criterion. If the device location data satisfies the second target market criterion, then the computer executable software code executes program executable code identifying the device as a matching device. The computer executable software code is adapted to execute a program executable code of a rule-based logic which identifies a matching device as a candidate device if the matching device is associated with a matching target candidate. The computer executable software code is adapted to process an advertising criterion. The computer executable software code is adapted to process a second student data from the student information system. The computer executable software code is adapted to execute a program executable code of a rule-based logic to determine whether the second student data matches the advertising criterion. If the second student data satisfies the advertising criterion, then the computer executable software code executes program executable code identifying the matching device as a target device. The computer executable software code is adapted to process an advertising data to electronically communicate to a target device. The computer executable software code is adapted to execute a program executable code electronically providing the advertising data to the target device.

In an embodiment, the computer software product is a directed advertising system software product.

### BRIEF DESCRIPTION OF THE DRAWINGS

The present invention in its several aspects and embodiments solves the problems discussed above and significantly advances the technology of student information systems, learning management systems and electronic advertising. The present invention can become more fully understood from the detailed description and the accompanying drawings, wherein:

FIG. 1 is a block diagram of an embodiment of a directed advertising system;

FIG. 2 is a block diagram of an embodiment of an Directed Advertising Server of FIG. 1;

FIG. 3 is a flowchart showing an embodiment of method steps which can be executed by a Directed Advertising module;

FIG. 4 is a flowchart showing an embodiment of steps which can be executed by a Coupon Redemption Module;

FIG. 5 is a screen shot of an example of a first interface of an embodiment of a Directed Advertising System which has an Educational Information System;

FIG. 6 is a screen shot of an example of a second interface of an embodiment of a Directed Advertising having an Educational Information System;

FIG. 7 is a screen shot of an example of an embodiment of an Academic Portion of the Directed Advertising and Educational Information System of FIG. 6;

FIG. 8 is a screen shot of an example Spirit Portion of the Directed Advertising and Educational Information System of FIG. 6;

FIG. 9 is an rule-based logic flow diagram of an embodiment of a directed advertising system;

FIG. 10 is a data flow diagram of an embodiment of a directed advertising system;

FIG. 11 is a combined rule-based logic flow diagram and data flow diagram of an embodiment of a directed advertising system;

FIG. 12 is Table 1 which is entitled “Examples Of Target Market Data”;

FIG. 13 is Table 2 which is entitled “Examples Of School Data”;

FIG. 14 is Table 3 which is entitled “Examples Of Device Data”;

FIG. 15 is Table 4 which is entitled “Examples Of School Selection Data”;

FIG. 16 is Table 5 which is entitled “Examples Of Parent And/Or Guardian Data”;

FIG. 17 is Table 6 which is entitled “Examples Of Sports Team Data”;

FIG. 18 is Table 7 which is entitled “Examples Of Academic Performance Data”;

FIG. 19 is Table 8 which is entitled “Examples Of Student Interest Data”;

FIG. 20 is Table 9 which is entitled “Examples Of Club Data”;

FIG. 21 is Table 10 which is entitled “Examples Of Political Club Data”;

FIG. 22 is Table 11 which is entitled “Examples Of Occupational Club Data”;

FIG. 23 is Table 12 which is entitled “Examples Of Advocacy Club Data”;

FIG. 24 is Table 13 which is entitled “Examples Of Mode Of Transportation”;

FIG. 25 is Table 14 which is entitled “Examples Of Church Data”;

FIG. 26 is Table 15 which is entitled “Examples Of Church Member Data”;

FIG. 27 is Table 16 which is entitled “Examples Of SIS And/Or DAS Interfacing System Functionalities”;

FIG. 28 is Table 17 which is entitled “Examples Of LMS And/Or LMS Interfacing System Functionalities”; and

FIG. 29 is Table 18 which is entitled “Example Of SCORM LMS Specifications”.

### DETAILED DESCRIPTION OF THE INVENTION

The technology disclosed herein is an advertising technology which provides new ways for schools, students, guardians and the merchants who serve them to communicate. The technology provides location directed targeting marketing on internet (web), wired, networked, wireless and mobile platforms.

Various embodiments are described hereinafter with reference to the accompanying drawings. It should be understood that the invention has many and varied embodiments and many different forms and aspects. The disclosure and the claims herewith should be broadly construed and should not be construed as limited to the embodiments set forth herein. Like numbers refer to like elements throughout.

The Student Location Directed Advertising System (“DAS”) can have one, more or all of a Student Information System (“SIS”) and/or Student Information System Portal (“SIS Portal”), a Learning Management System (“LMS”) and/or Learning Management System Portal (“LMS Portal”), and/or other systems and/or portals where registered users exist. In an embodiment, an SIS and/or SIS Portal can be integrated into the Student Location Directed Advertising System (“DAS”), or vice versa, “DAS”. Herein, an “SIS” and an “SIS Portal” are used synonymously unless otherwise indicated. The DAS can either have the SIS and/or LMS as an integrated portion of the DAS or receive information from an unincorporated SIS by means such as a portal or other interface.

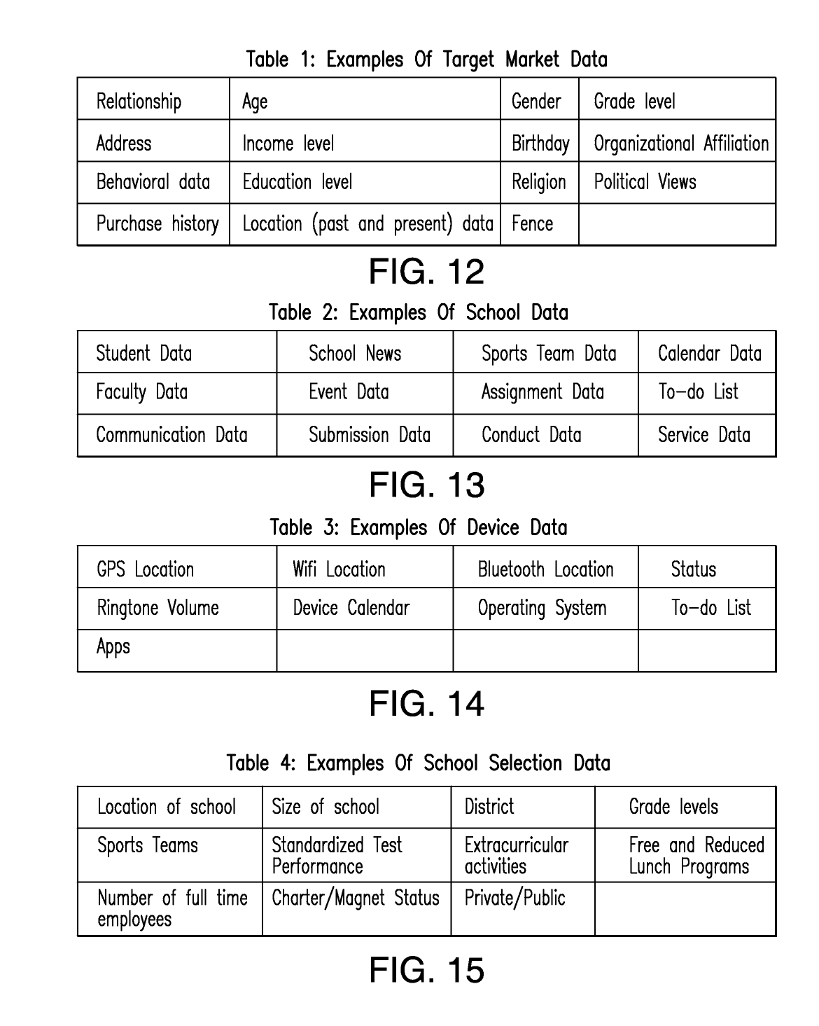

In an example, a DAS can communicate banner advertisements, discount coupons or other advertising communications or offers to one or more marketing target and/or one or more target markets based on predetermined criterion and/or criteria and/or computer generated criteria, such as in non-limiting example age, gender, athletic team affiliation, or other data (FIG. 12; Table 1). In an embodiment, students, parents, and teachers can access, view, and update educational information such as grades, homework, conduct and other information. Herein, the terms “DAS”, “DAS-Token”, “Token”, “Spirit” and “Token (Spirit)” are used synonymously to refer to embodiments of the DAS which can communicate advertising and other information to its users.

Herein, any system and/or software disclosed can execute rule-based logic and/or other processing and/or other decision making by processing and/or using a single “criterion” or a plurality of criterion herein as “criteria”. Where a decision or processing step can be executed based on a single criterion, the disclosure is intending to be broad and discloses a single criterion, at least one criterion, or criteria. There is no limitation to the upper number of criteria which can be used. There is no limitation that criteria (plural) be used, if a single criterion (singular) can allow for a processing or logical step to be made.

Herein, the term Student Information System, “SIS”, is a very broad term which in addition to its ordinary and customary meaning means and encompasses a software application which processes, holds, has or manages data associated with a student. An SIS is synonymous with student information management system (“SIMS”); can have, interface with or utilize a student information system portal (“SIS Portal”), can have, interface with or utilize a student records system (“SRS”); can have, interface with or utilize a student management system (“SMS”); can have, interface with or utilize a campus management system (“CAMS”), can have, interface with or utilize a student management system portal system (“SMPS”); and/or can have, interface with or utilize a or school management system (“SCHMS”). The term “SIS” is intended to encompass one, more or all of these systems, as well as their equivalents and other systems satisfying the data, logic and/or processing requirements of an SIS. Herein, the term SIS is intended to mean and encompass a learning management system “LMS”. Herein, the term SIS is intended to mean and encompass an Educational Information System (“EIS”). An SIS can have, interface with or utilize an education technology suite (“ETS”). An SIS and/or any one or more of the systems disclosed herein, i.e. SIS, SIMS, SIS Portal SRS, SMS, CAMS, SMPS, SCHMS, LMS, EIS, ETS and/or any associated portal or interface can provide data to the DAS.

In an embodiment, an SIS can be used as an enterprise resource planning (“ERP”) system for school, corporate, church, organization, entity, group, customer, portal or other users, customers and/or marketing targets and/or market participants.

The DAS and any associated systems (e.g. SIS) can vary in size, scope and capability, from packages that are implemented in relatively small organizations to cover student or church records alone, to enterprise-wide solutions that aim to cover most aspects of running large multi-campus organizations and/or companies and/or other organizations. Many systems can be scaled to different levels of functionality by purchasing add-on “modules” and can typically be configured by their home institutions to meet local needs.

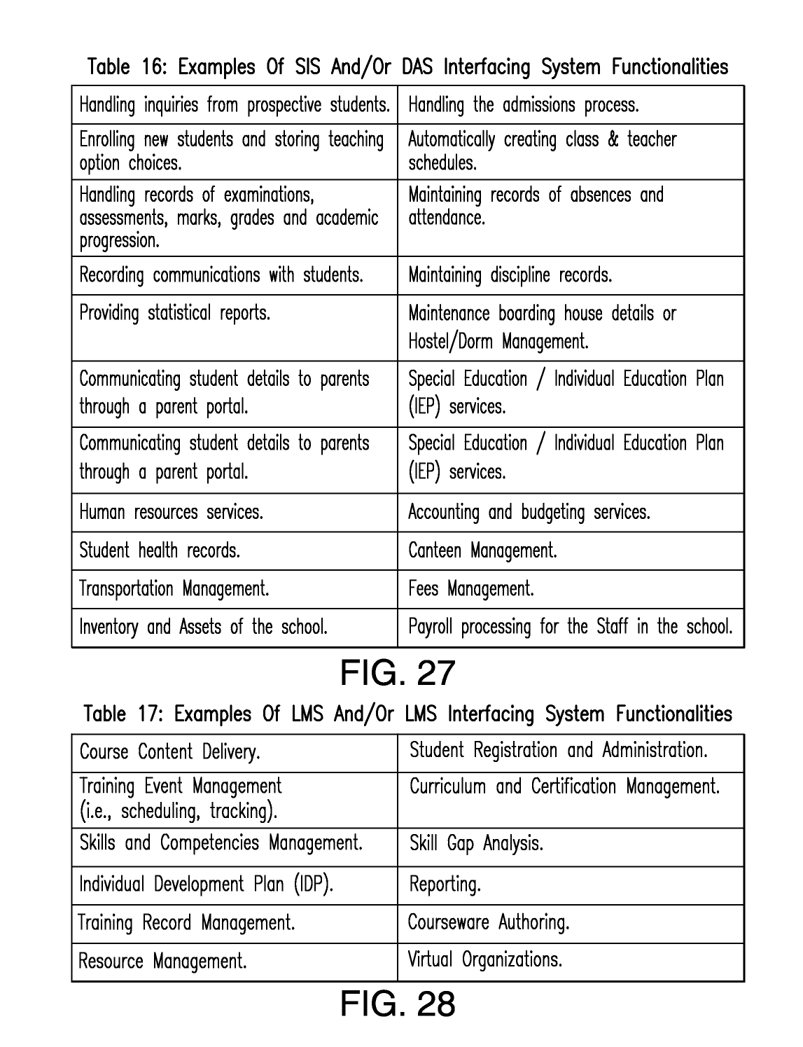

An SIS and/or other system associated with a DAS can execute one or many functions, including but not limited to one or more of the functions listed in FIG. 27 (Table 16).

Herein, the term “Educational Information System (“EIS”) means and encompasses a system used to store educational records. It is synonymous with and included as part of an SIS.

Herein, the term “Learning Management System” (“LMS”) in addition to its ordinary and customary meaning means and encompasses a software application for the administration, documentation, tracking, reporting and delivery of e-learning education courses or training programs. The scope of “LMS” includes without limitation a range of systems for managing training and educational records to software for distributing online or blended/hybrid elementary school, middle school, high school and/or college courses over the internet with features for online collaboration. Many elementary schools, middle schools, high schools, colleges and universities use one or more LMS to deliver online courses and augment on-campus courses. Corporate training departments and Churches can use one or more LMS to deliver online training, as well as automate record-keeping and employee and member registration.

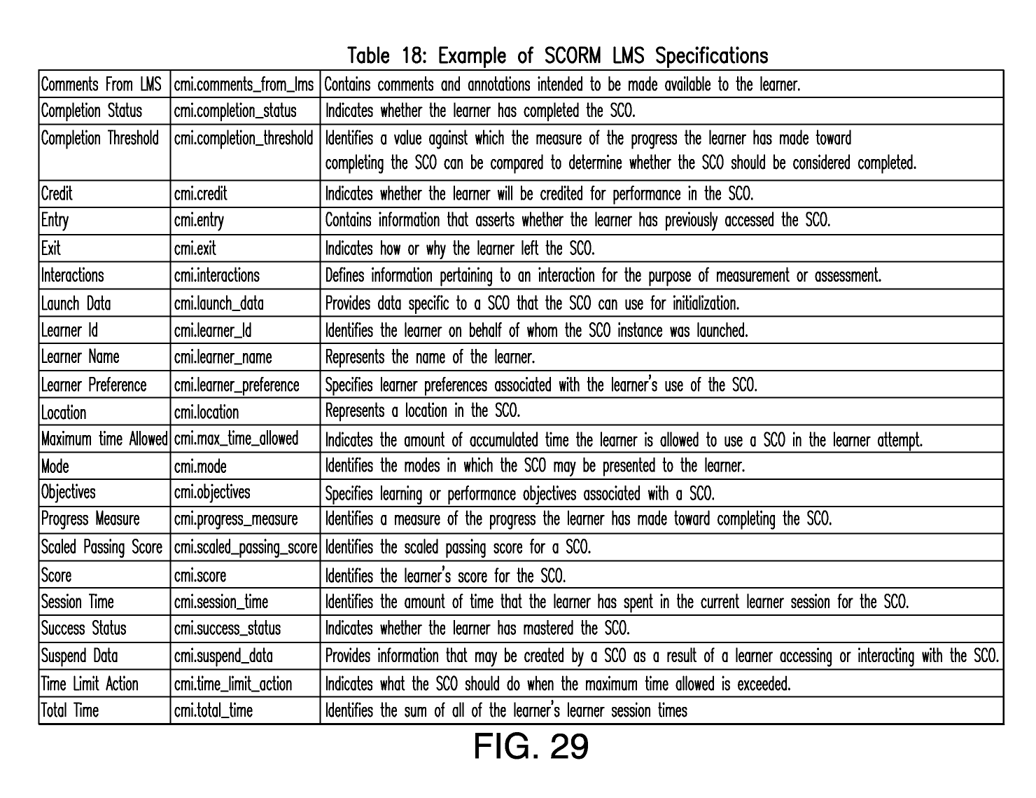

In an embodiment an LMS can be a software application or Web-based technology used to plan, implement, and assess a specific learning process. An LMS provides an instructor with a way to create and deliver content, monitor student participation, and assess student performance. A learning management system can also provide students with interactive features such as threaded discussions, video conferencing, online quizzes, online work, online tests and discussion forums. The Advanced Distance Learning group, sponsored by the United States Department of Defense, has created a set of specifications called Shareable Content Object Reference Model (“SCORM”) to encourage the standardization of learning management systems (FIG. 29; Table 18).

An LMS can be stand-alone or part of an SIS. Herein, “SIS” is meant to encompass LMSs as part of an SIS.

In non-limiting examples an LMS can execute one or many functions, including but not limited to one or more of the functions listed in FIG. 28 (Table 17).

In an embodiment, an LMS can have, interface with or utilize an education technology suite (“ETS”) which can have a set of software tools containing student information, learning management, web based student registration and enrollment, attendance tracking and notification, faculty management, student scheduling, grade book, discipline management and reporting, class discussions and communications, powerful reporting tools, integrated iPhone, Android, or other smartphone or other electronic tools, revenue generation with SPIRIT, revenue loss prevention tools (for example those that alert administrators to potential funding losses) and more into a single suite that seamlessly shares data between the entire set of tools and applications. Both the LMS and ETS can be part of an SIS, or can be stand-alone.

In an embodiment, the SIS (e.g. Chalk (Lex)) is an example of a software system used to track student information, such as but not limited to grades, attendance, conduct, and other student record information (“SIS-Lex”).

Herein, the term Church Management System (CHMS) means and encompasses a software application for the administration, management, communication, tracking attendance, tracking membership, tracking contributions, and reporting of people and finances associated with a church or other religious entity.

Any system herein can be adapted to be implemented as a web application, a smartphone app, a mobile phone app, a tablet app, a laptop app, a personal data device app and mobile app. In its several embodiments, the DAS and/or SIS can be adapted to be implemented as a web application, a smartphone app, a mobile phone app, a tablet app, a laptop app, a personal data device app and mobile app. The CAMS and CHMS can serve analogous functions for the members of the respective campus or church groups. Herein the term “app” is to be broadly construed to in addition to its ordinary and customary meaning to also encompass and mean any software application and/or hard coded application and/or software means which can run any part of or all of the computer software and methods disclosed herein. Herein “app”, “application” and “software application” are used synonymously. It is intended that this disclosure and the term “app” include individual devices, multiple devices, cloud-based systems and distributed system and any devices which interface with any such systems. Software as a service and alternative processing and/or computing platforms are also encompassed and hereby disclosed.

In the context of a campus, in its several embodiments, the CAMS can be adapted to be implemented as a web application (app), a smartphone app, a mobile phone app, a tablet app, a laptop app, a personal data device app and mobile app. In an embodiment, the CAMS module and the DAS module can be present on the same screen simultaneously and for any desired length of time, including permanently. In an embodiment the CAMS and DAS can be used together and/or combined and/or integrated. Here the joint and/or combined use of the CAMS and DAS, as well as the integrated embodiment can be referred to as a “CAMSDAS”. In non-limiting example, the CAMSDAS can provide functionality to simultaneously location, check attendance, membership, contributions, and find a discount for a product or service of interest.

In an embodiment, the SIS (e.g. SIS-Lex) module and the DAS module can be present on the same screen simultaneously and for any desired length of time (including permanently).

Herein, the term Entity Management System (EMS) means and encompasses a software application for the administration, management, communication, tracking attendance, tracking membership, tracking contributions, and reporting of people and finances associated with an entity of any type. This can include any entity, such as but not limited to a school, church, charity, group, company, institution, gathering, cause, political party or other group.

In an embodiment the SIS and DAS can be used together and/or combined and/or integrated. Here the joint and/or combined use of the SIS and DAS, as well as the integrated embodiment can be referred to as a “SISDAS”. In another embodiment, the SIS and DAS can be separately and/or independently. Herein, any embodiment of the DAS can have or be used with an SIS and/or any other system which can provide data for processing by the DAS.

The SISDAS can provide functionality to simultaneously check location, grades and assignments, and find a discount for a product or service of your interest.

In an embodiment, the SIS can have an academic module and can exchange data with an app, such as or non-limiting example a web app, a mobile app, a desktop app, or a laptop app. For example, an app can be used by a school to allow students and parents to access location, grades, homework assignments, assignment status, class work assignments, discipline records, attendance records, and other academic information (FIG. 13; Table 2). This data can be updated in real time as new data can be entered.

In an embodiment, travel patterns of one or more individuals and/or devices can be analyzed by the DAS. The DAS can analyze and predict location patterns based upon historic and/or real time location data. In an embodiment, the DAS can track the location of the user to determine a pattern that can be associated with a behavior. In one example, the DAS finds that a user frequents a restaurant, e.g. McDonalds at 7 p.m. each evening after their football practice. The DAS can use this data to target another restaurant, e.g. Burger King, advertisement to the user as they pass the Burger King restaurant after practice since it can be assumed the user is likely headed to eat at McDonalds.

The DAS can enable advertisers, such as corporate sponsors or others to push out advertisements and coupons to one or more users of an DAS, SIS, SISDAS, CAMS, CHMS, CHMSDAS and/or CAMSDAS including to every person using a school, church, entity or organization app (e.g. all students, parents, teachers, members, employees, associates, contractors, service providers and others). In an embodiment, the application and/or its components utilize the screen space of a display device, such as a phone efficiently. This efficiency can result from rule-based logic executed to determine what data can be communicated with a user. For example, it is not efficient to send a grocery store coupon to a student too young to read it, or to send a child-targeted coupon to an adult user not familiar with the child-directed content. In another example, it is not efficient to send a male recipient a coupon for a female oriented product.

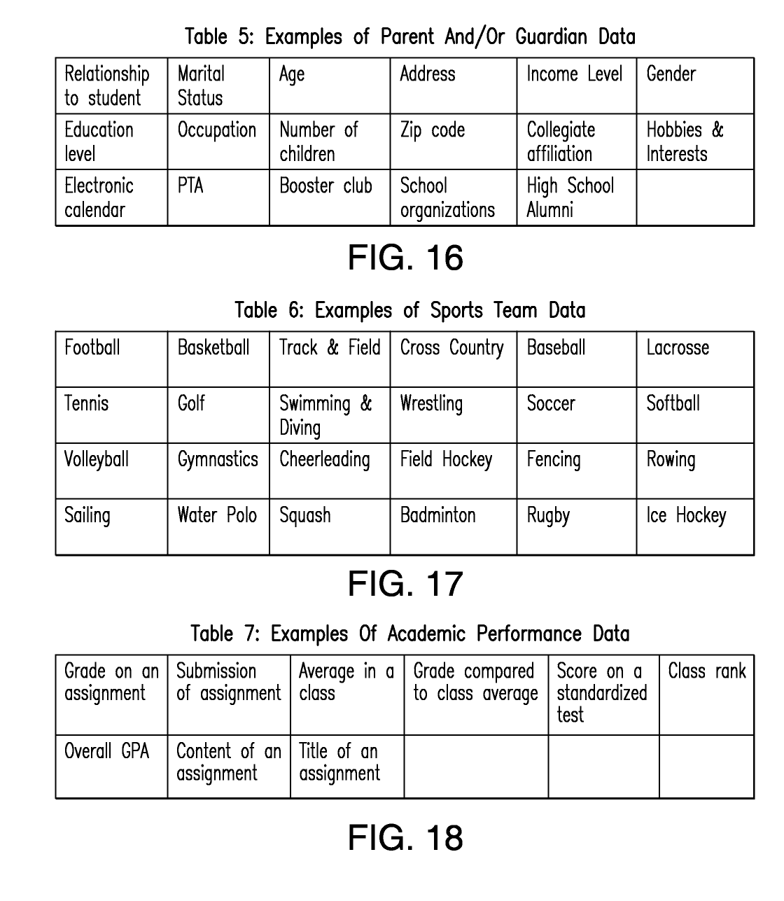

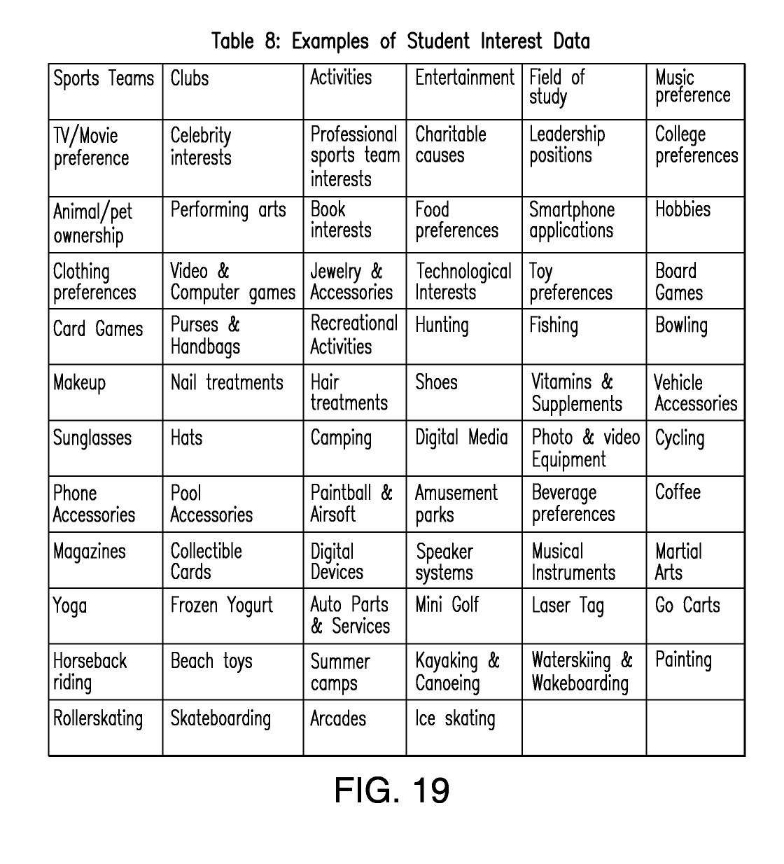

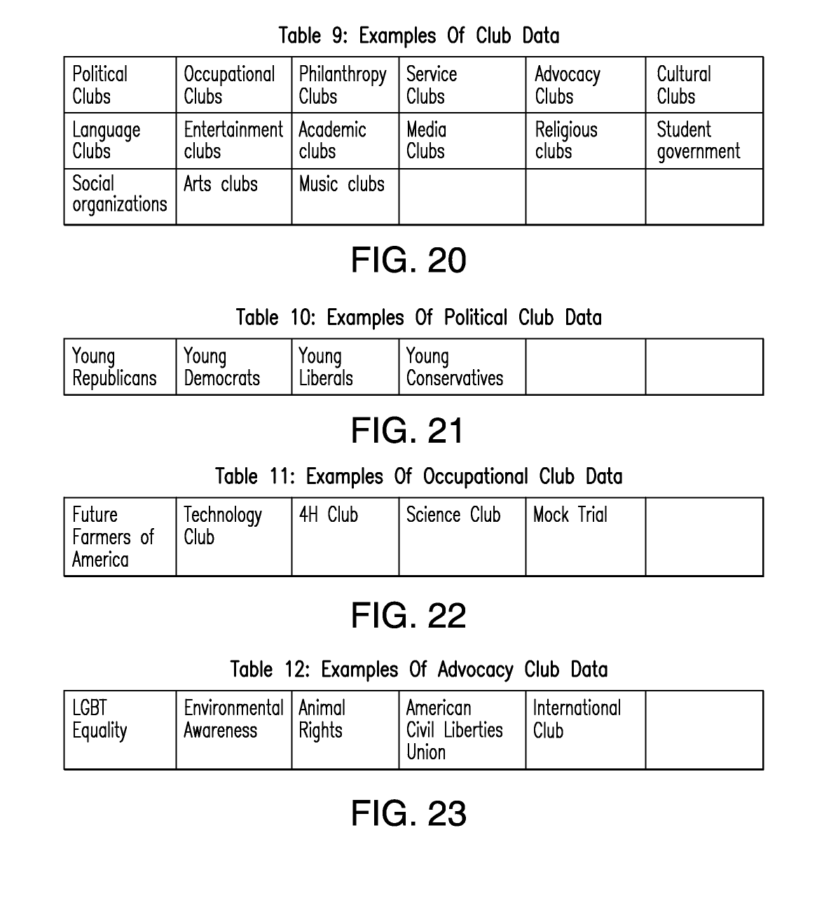

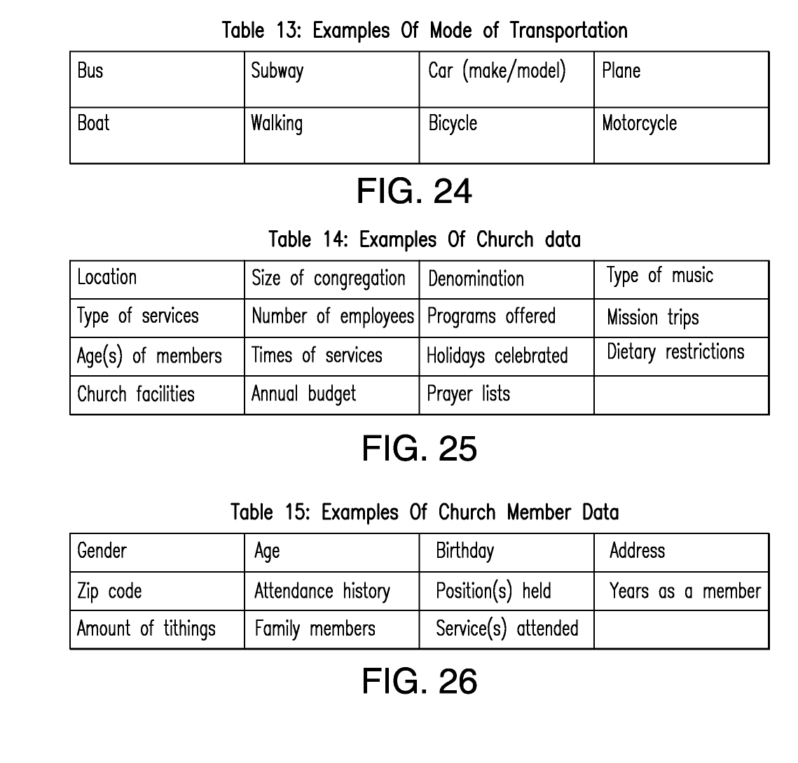

In an embodiment, an advertiser (e.g. merchant, company, organization or individual) can communicate an ad and/or a coupon to a marketing target. In non-limiting example, an advertiser can electronically communicate (e.g. email, text, push notification or electronic notice) to a target market group based upon a predetermined and/or a dynamic advertising criterion or criteria, such as: type of school (FIG. 15; Table 4), location data, parent data (FIG. 16; Table 5), student data (FIG. 19; Table 8), alumni data, guardian data, friends data, mode of transportation data (FIG. 24; Table 13) common interest data, or other data. Advertising criteria can vary broadly. Advertising criteria can also comprise interest data, fence data (distance from expected location), sports data, team data (FIG. 17; Table 6), organizational participation data (FIG. 20, Table 9; FIG. 21, Table 10; FIG. 22, Table 11; FIG. 23, Table 12), bibliographic data, non-bibliographic data, geographical data, GPS data, gender data, age data, income data, grades and/or academic performance data (FIG. 18; Table 7). Herein “bibliographic data” in addition to its ordinary and customary meaning means and encompasses any data which identifies, describes, locates, associates or otherwise is an attribute of an individual. This disclosure is not limited as to the type and/or kind of advertising data and/or criteria employed by the SIS and/or DAS and/or any system of or associate with such SIS and/or DAS. The data used as advertising and/or target market data can be intentionally disclosed herein and very broad and wide ranging.

In an embodiment, a student information system or Church Management System can pass information to a DAS which can process this information to determine a relevant advertisement for a user and or market target. Non-limiting examples of types of data can include demographic information, information about a school's or church calendar, an individual's schedule, a student's academic information or a church member's attendance (FIG. 25, Table 14, FIG. 26, Table 15).

In an example, the DAS can receive a data that a user is a 16-year-old female and can select a nail salon advertisement for the user. In another example, the DAS can receive a data that a student's schedule has or is changed to include a Biology course and can send this user an advertisement for a biology textbook, or specifically the required Biology textbook for the given course.

In an embodiment an LMS can pass information to a DAS which can process this information to select a relevant advertisement for a user, or target market. Non-limiting examples of types of data can include location data, assignment data, student submission data, and academic data. In another example, a user who is associated with a data regarding an essay assignment or other relation to President Abraham Lincoln can be shown advertisements on Lincoln biographies or a new movie about Lincoln and/or other history-related products.

In an embodiment, a DAS can receive data from a CAMS, CHMS, SIS, LMS, or other system. This data can include information about the location and schedule of one or more users. Data such as the location of the school and the locations and times of activities and events can be sent in real-time from the SIS. The advertising system can also receive data in real-time from the LMS, such as data about the time and location of a user submission or when they access the system. This information can be combined to determine the approximate location of a user of the system at many times.

In an embodiment, the DAS can receive a data from a CHMS, CAMS, SIS and/or LMS relating an SIS system user to a sports team, e.g. the user is a member of a soccer team. In an embodiment a location and a time data can be processed, e.g. that the soccer team has an away game at 4:00 p.m. in Orlando on a given date, e.g. today. The system can then communicate an advertisement for a restaurant, e.g. McDonalds, in Orlando to be sent to the user on the given date. Optionally, the advertisement can be sent at a given time, e.g. 6 p.m., and be for a give date period and/or time period.

In another embodiment, the DAS system receives a data that a user has an essay due in both History and English class at midnight. The users submits the essay for English at 8 p.m. but has not yet submitted the essay for history. The DAS can select and communicate an advertisement for the user for a nearby coffee shop, e.g. Starbucks. In an embodiment, a DAS can receive data from a device to determine the physical location of the user. This data can be the IP address and location of a computer that the user connects to the SIS, LMS, CHMS, CAMS or DAS. It can also be location data gained from a user's mobile device via Wi-fi, Bluetooth, or GPS. The DAS and associated system can without restriction optionally process date, time, place and other data (FIG. 14; Table 3).

In an embodiment, the DAS can receive the GPS location of a user from a user's mobile device, e.g. cell phone and/or smartphone. By such GPS data the DAS can process an associated location, e.g. the mall or an address. The DAS can then use the result to select and communicate an appropriate advertising message, e.g. an advertisement for a store in the mall to be sent to the user.

In an embodiment, the DAS can process location relationally against a hypothetical boundary or location criteria herein referred to as a “fence”. The term “fence” as used herein means and encompasses a distance, perimeter and/or an area surrounding and/or associated with a business or location within which an advertiser wishes to target consumers. A “fence” can be any set of location criteria, parameters or limitations set in or generated by the DAS. Thus, the “fence” relates to any location criteria and is not geometrically limited.

In an embodiment, the DAS can receive a GPS location of a user from a device, such as a mobile device. The system can check the GPS location and process that data against a fence associated with a location, e.g. a physical store. If the GPS location is within the fence, i.e. satisfies the location criteria of the fence then the system can select an advertisement from the physical store.

In an embodiment, the DAS can adapt its advertisement selection criteria in real-time based upon a user's interaction with the system. In the first step, the DAS selects an advertisement that is “pushed” to the user based upon their location and the time.

In an embodiment, if the user interacts with an advertisement, the system can record data such as the product category of the advertisement, the advertiser, the time of the interaction, the location of the interaction, and whether or not the user redeems the deal. This information can then be used to better select advertisements for this user and similar users in the future.

In a non-limiting example, the DAS can push an advertisement to a user for a brand of tennis shoes while the user is inside the mall on a Saturday afternoon. The user can view the advertisement and complete the offer. This user can then be more frequently pushed advertisements for similar products, e.g. Nike Shoes, and other athletic apparel when they are at this mall, or on Saturday afternoons. This past offer interaction data can also be used to satisfy an offer's selection criteria. If an advertiser wishes to push a coupon out to all of those users interested in running when they visit the mall, the advertisement might be shown to all users at the mall who are members of the track team, as well as those users who have previously viewed and/or interacted with a shoe coupon before.

In another example, the DAS can push a McDonald's coupon to a user at 10 a.m. and 10 p.m. each day on Monday through Saturday. The user only views the coupon that is sent out at 10 p.m. on Friday and 10 p.m. on Saturday. The DAS can adapt to this user behavior and will now be less likely to receive fast food coupons in the morning or on weekday evenings. In this example, a coupon for a McDonald's breakfast sandwich might not be shown to a user that meets the selection criteria when they pass a McDonalds in the morning due to the adaption from previous and/or prior behavior.

In an embodiment, the DAS can change targeting frequency based upon user interaction with advertisements. For example, some users can be pushed an advertisement. If a high percentage of them interact with the advertisement, it is then pushed to others in the same demographic. A high percentage of similar users interacting with one advertisement can become a selection criterion for another advertisement. In one example, 60% of the players on the football team view a coupon for a fishing pole. Tom, a member of the football team, does not view this advertisement. However, when Tom passes by the local outdoor store the next day, he is served an advertisement for some fishing hooks because his teammates interacted with the previous fishing advertisement.

In a non-limiting example, an advertisement for a hamburger coupon can be pushed out to juniors on the football team. Based upon the percentage of, e.g. 75%, of the juniors interact with this advertisement and the DAS can then send the advertisement to the rest of the football team.

In an embodiment, the DAS can receive data about a student's schedule from an SIS and about a student's physical location. The system can then select an advertisement to be pushed to the user based upon a combination of their physical location and schedule data.

In non-limiting example, according to the student's schedule data from the SIS, it is lunch time. The DAS system also knows the physical location of the user from their smartphone. Based upon this information, the system can send the student an advertisement for a restaurant near their current location or near a path they typically take.

In yet another example, the DAS can push an advertisement to a student for a book they will be reading next week in English class when they enter a bookstore and/or are within the fence of a bookstore. The fence of the bookstore can be defined in a variety of manners, e.g. as a geographic area, or as a particular isle, or as a display in the bookstore. One or more fences can be applied to any location. For example, a fence based on geography, then a fence based on a location within a destination, then a fence based upon a particular item and/or service within the destination.

In an embodiment, the DAS can construct a user profile that can determine what is best to advertise to a given user, when is the best time to advertise it to the given user, and the user location in which it can be most effective to present the advertisement. The system can also consider why an advertisement can or can not be shown due either to predetermined or dynamically created system rules and/or business rules and/or logical rules. The system uses data collected in the methods herein to create this user profile and target the advertisements.

In another non-limiting example, the DAS can select a candy bar advertisement to communicate to a user. The DAS can optionally determine when is the best time to show this advertisement the user, such as directly after school ends. The DAS can optionally also determine the best location for the advertisement, such as when the user is at the grocery store. Optionally, a rule can be applied such that even though the DAS has executed a rule-based logic to select the candy bar advertisement, it might not be allowed by a rule to show the selected advertisement to the user (e.g. a student) until after school hours. In embodiments, the rule-based logic can be determined for example by rules of a school, organization, entity, user, law or other basis. There is no limitation regarding what can constitute a basis for a rule of the rule-based logic.

A computer system, according to various embodiments, has at least one processor and memory. In embodiments, the computer system can be configured for: receiving educational and demographic information for at least one student of an educational institution; receiving an indication that an advertiser wishes to display an advertisement to at least one individual selected from a group consisting of: students who satisfy predetermined criteria; relatives of students who satisfy the predetermined criteria; teachers; administrators and school employees who satisfy predetermined criteria and alumni who satisfy predetermined criteria; using the educational information and/or demographic information to determine whether the user satisfies the predetermined criteria; and in response to determining that the user satisfies the predetermined criteria, displaying the advertisement to one or more individuals selected from a group consisting of: the student; and one or more relatives of the student, school employees or alumni.

A non-transitory computer-readable medium, according to various embodiments, stores computer-executable instructions for: retrieving educational information and demographic information about a user, selecting at least one advertisement based at least in part on the educational and/or demographic information about the user; and displaying the at least one advertisement to the user.

A computer system, according to various embodiments, has at least one processor and memory. In embodiments, the computer system can be configured for: receiving an indication of at least one product to be purchased by a customer, receiving an indication of an organization associated with the customer; identifying any special offers available to persons associated with the organization which apply to the at least one product to be purchased by the customer; and applying the special offers to a purchase price of the at least one product to be purchased by the customer.

Throughout this application, it is understood that the terms “computer executable software code”, “computer readable code”, “program readable code” and computer executable code are used synonymously and in addition to their ordinary and customary meaning encompasses the meaning of a set of instructions that can be read by and executed by a computer processor and/or system and/or computing device. The application is not limited regarding the nature and/or type of computer executable software code and encompasses any and all code readable and executable by a computer and encompasses and equivalents and/or means, such as the terms “a computer executable program code means” and “a computer readable program code means” which are used herein synonymously and which are intended to encompass any time of software and/or program code and/or instructions readable and/or executable by a computing device and/or computer.

All of the embodiments herein can be made, used, implemented and executed by computer readable program code means. There is no limitation as to the type and nature of computer readable program code means which can be used to achieve the methods and calculations disclosed herein. The software products are not limited and can broadly be any software and or application product capable of processing the numerical methods and calculations disclosed herein. The software products can be applications, subroutines, mobile applications, smartphone applications, wireless applications, cloud-based applications, cloud-based services, or any by computer readable program code means adapted to achieve the methods disclosed herein. There is no limitation on the nature of the product whether the application is source code, compiled code, non-compiled code, downloaded code, compressed code, executable code. This disclosure expressly encompasses any product which provides the method herein to a use and which can provide to, implement, execute, support or enable a user to practice, make or use any method disclosed herein in any embodiment or part thereof.

All of the embodiments herein are transformative in nature. The disclosed methods are to be executed by a computer to transform data regarding at least one item with at least one attribute and an at least one uncertainty by computer means to achieve an output which can be perceived and utilized by a user of the methods disclosed herein.

The embodiments herein are highly transformative and are technological methods and means which advance computer and software technology and which are robust and transform input, parameters, criteria, knowledge and/or data into useful and value added information upon which a user can base a decision, or which is transformed through technology into information which in itself is a decision, a solution, a result, a product, an output and/or outcome. The transformation of input and/or data by the computer and software embodiments herein achieves decision support and/or decision results previously not possible. The embodiments herein are transformation technologies and are also computer integral technologies to achieve the transformations (e.g. computer processing, calculations, values, results, choices, solutions and outcomes) disclosed and achieved herein.

Numeric values and ranges herein, unless otherwise stated, also are intended to have associated with them a tolerance and to account for variances of design and manufacturing. Thus, a number can include values “about” that number. For example, a value X can be also intended to be understood as “about X”. Likewise, a range of Y-Z can be also intended to be understood as within a range of from “about Y-about Z”. Unless otherwise stated, significant digits disclosed for a number are not intended to make the number an exact limiting value. Variance and tolerance can be inherent in mechanical design and the numbers disclosed herein are intended to be construed to allow for such factors (in non-limiting e.g., ±10 percent of a given value). Likewise, the claims are to be broadly construed in their recitations of numbers and ranges.

A Directed Advertising and Educational Information System, according to embodiments, includes: a school portion that allows students, parents, or others to access educational information about a student; and a DAS that distributes special offers (e.g., coupons) and/or other advertisements to users of the application.

The educational information maintained by the system's school portion can include information such as a student's location data, class schedule, grades, and homework assignments and due dates, the student's disciplinary record, relevant school news, and other academic information. The demographic information maintained by the system can include information such as the students' age, gender, grade level, sports team affiliation, club memberships, and other demographic information. This demographic information can be provided by the users and captured in the form of a survey. The survey data can be entered by one or more users. Multiple surveys can be used. For example a student, administrator, parent or other individual and/or multiple people can enter survey data and/or answers to survey questions. In another example a student can enter SIS data, answer survey questions, and enter any data the student desires. There no limitation to the information and/or data a student or other person or people can enter into an SIS. The DAS can be configured to generate and/or distribute advertisements that include special offers such as, for example, deals, traditional coupons, or “frenzy coupons” that need to be activated by a number of users in order to be redeemable. In various embodiments, the DAS can direct advertisements to users based, at least in part, on a student's location data, educational information, demographic information and/or other information stored by the system. For example, a student that participates in a club can receive, from the DAS, advertisements that are relevant to the club's activities (e.g., students in photography club can receive discount coupons for 20% off of photo prints at a store that develops/prints photographs). A parent of a student aged 6-14 can receive an offer for an orthodontist service. Offers can also be displayed based upon a combination of filters, such as to male students aged 14-18 who made an A in math and are also on the baseball team.

In embodiments, the DAS can be configured to generate advertisements and to direct the advertisements and/or special offers (e.g., discounts) to students based on any suitable information obtained from the system's school portion. Such information can include, for example: the student's gender; the student's age; one or more courses that the student has taken in the past, can be currently enrolled in, or can be enrolled to take in the future; the student's current class (e.g., freshman, sophomore, etc. . . . ); one or more of the student's extracurricular activities (e.g., clubs, athletic teams, or other organizations that the student can be a member of), the student's past or current performance in school (e.g., the student's grades in a course, overall GPA, and/or class rank; the nature of the student's classes (e.g., honors or AP classes, or special education classes); academic or other information regarding the student's siblings; the frequency of the student's pictures in school publications, such as school yearbooks; leadership positions held by the student; performance-related honors that have been bestowed on the student (e.g., academic or athletic honors); any work-study programs (e.g., co-ops or internships) that the student participates in; homework assignments or classwork assignments; content of homework or classwork assignments (e.g. topic or title of an essay); upcoming scheduled activities (e.g., scheduled athletic events or field trips); the student's attendance record; any other suitable information; or any combination of the above types of information.

For example, the DAS can be configured to generate and/or distribute advertisenments that include discounts for manicures to female members of the school's cheerleading squad. As another example, students who have maintained at least a 3.5 grade point average in English can receive a discount on books purchased from a local bookstore (since such students are more likely than others to purchase books on a regular basis).

In embodiments, the DAS can also be configured to generate advertisements and/or distribute advertisements to non-student users of the system. Such users can include, for example: parents of students; teachers; school administrators; and/or alumni.

In embodiments, any time a user redeems a coupon or offer with the business making the offer, a designated percentage or amount of the sale made during the redemption will be donated to an educational institution. In certain embodiments, the advertisements disclosed herein can include an offer under which the offering party can make a contribution to the educational institution generally and/or to an entity associated with the educational institution if the offer can be accepted. For example, the offer can specify that 10% of any purchase made using a coupon for art supplies can be donated to the school's art department.

The DAS can provide advanced analytics and analysis for the businesses and schools. By tracking offer views and redemption, statistics can be available that allow businesses to see the demographic and educational information, in aggregate, of those users that have viewed or redeemed an offer. Redemption of all offers can be stored in a centralized database where advertising data related to educational or demographic information can be easily mined.

Without limitation, various embodiments of the present invention can be, for example, embodied as a computer system, a method, or a computer program product. Accordingly, various embodiments can take the form of an entirely hardware embodiment, an entirely software embodiment (e.g., one or more computer application, such as an “app” to be implemented on a mobile device and/or an application to be implanted on a desktop computer), or an embodiment combining software and hardware aspects. Furthermore, embodiments can take the form of a computer program product stored on a computer-readable storage medium having computer-readable instructions (e.g., software) embodied in the storage medium. Various embodiments can take the form of web-implemented computer software. Any suitable computer-readable storage medium can be utilized including, for example, hard disks, compact disks, DVDs, optical storage devices, and/or magnetic storage devices.

Various embodiments are described below with reference to block diagrams and flowchart illustrations of methods, apparatuses (e.g., systems) and computer program products. It should be understood that each block of the block diagrams and flowchart illustrations, and combinations of blocks in the block diagrams and flowchart illustrations, respectively, can be implemented by a computer executing computer program instructions. These computer program instructions can be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions can also be stored in a computer-readable memory that can direct a computer or other programmable data processing apparatus to function in a manner such that the instructions stored in the computer-readable memory produce an article of manufacture that can be configured for implementing the function specified in the flowchart block or blocks. The computer program instructions can also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of mechanisms for performing the specified functions, combinations of steps for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and other hardware executing appropriate computer instructions.

The entire system can be accessible from various computer platforms, including mobile devices. Mobile devices can have native apps created in order to allow quick access to the system. These mobile apps can launch the responsive web platform on the mobile device and also allow access to the communication services on the mobile device. This can allow notifications to be pushed out to users when new offers or academic information are uploaded into the system. In order to increase the speed of the app, information concerning the student can be saved on the mobile device.

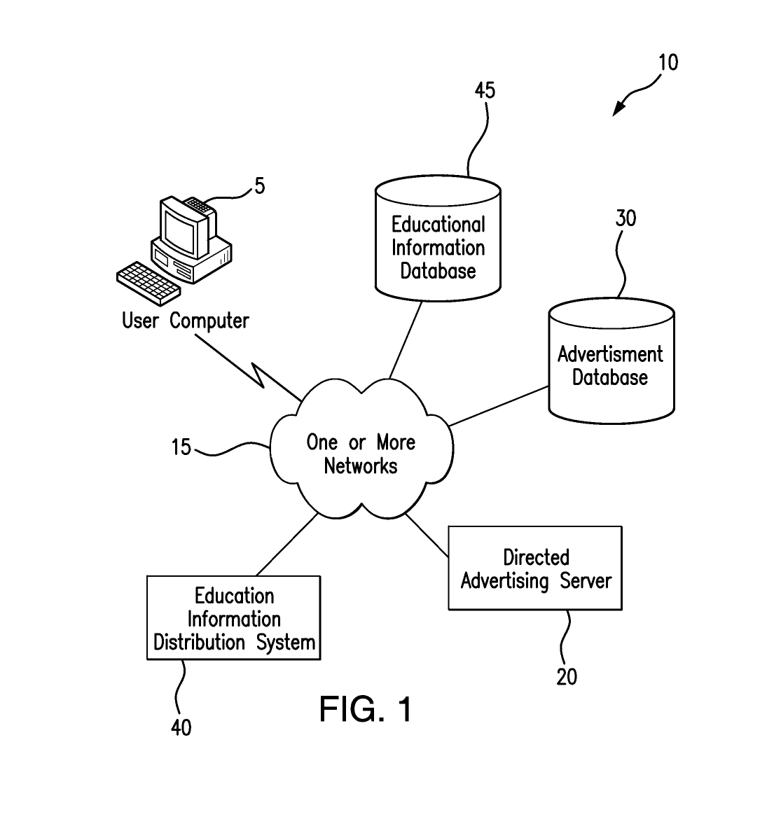

FIG. 1 illustrates a block diagram of a directed advertising and education information system 10 according to an embodiment. The directed advertising and education information of system 10 can have at least one user computer 5 (e.g., a wireless computing device such as a tablet computer or smartphone, laptop, or other suitable computer), one or more computer networks 15, a direct advertising server 20, an advertisement database 30, an education information distribution system 40, and an educational information database 45. The one or more computer networks 15 facilitate communication between the user computer 5, directed advertising server 20, advertisement database 30, education information distribution system 40, and educational information database 45. These one or more computer networks 15 can include any of a variety of types of computer networks such as the Internet, a private intranet, a public switch telephone network, or any other type of network. In an embodiment, the communication links between the user computer 5, directed advertising server 20, advertisement database 30, educational information distribution system 40, and educational information database 45 can be implemented via the internet and/or via a suitable Local Area Network.

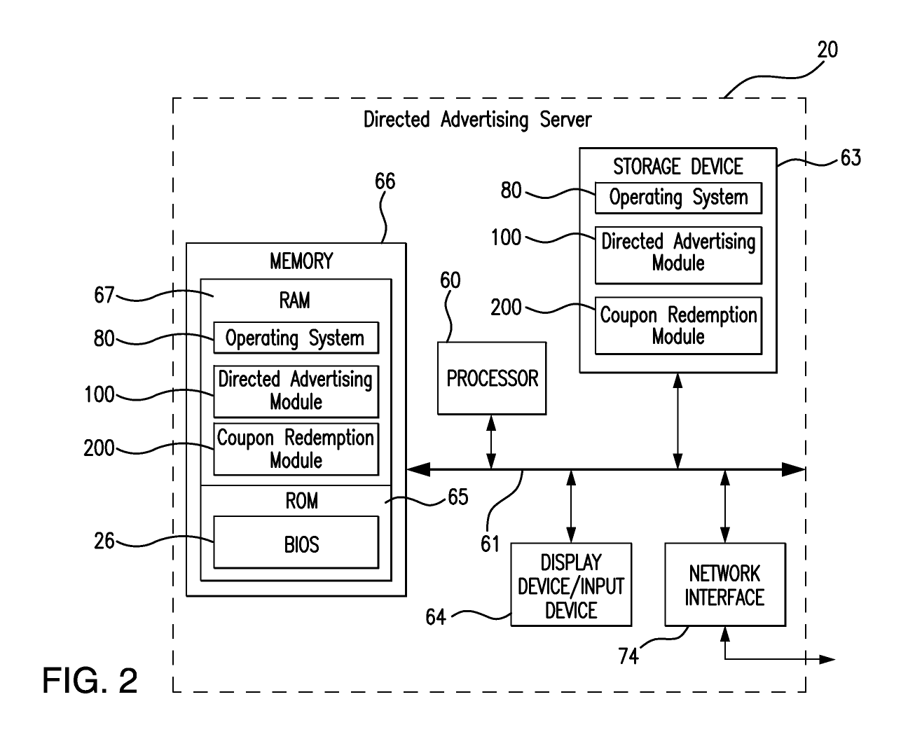

FIG. 2 illustrates a block diagram of an exemplary embodiment of the Directed Advertising Server 20 of FIG. 1. The embodiment of FIG. 2 illustrates a Directed Advertising Server 20 which has a processor 60 that communicates with other elements within the directed advertising server 20 via a system interface or bus 61. The directed advertising server 20 can, in various embodiments, include a display device/input device 64 for receiving and displaying data. This display device/input device 64 can be, for example, a keyboard, voice recognition, or pointing device that can be used in combination with a monitor. The directed advertising server 20 further includes memory 66, which preferably includes both read only memory (ROM) 65 and random access memory (RAM) 67. The server's ROM 65 can be used to store a basic input/output system 26 (BiOS) that contains the basic routines that help to transfer information between elements within the directed advertising server 20.

In addition, the directed advertising server 20 includes at least one storage device 63, such as a hard disk drive, a floppy disk drive, a CD Rom drive, or optical disk drive, for storing information on various computer-readable media, such as a hard disk, a removable magnetic disk, and/or flash memory. Each of these storage devices 63 can be connected to the system bus 61 by an appropriate interface. The storage devices 63 and their associated computer-readable media provide nonvolatile storage for the directed advertising server 20. It can be important to note that the computer-readable media described above can be replaced by any other type of computer-readable media known in the art. Such media include, for example, magnetic cassettes, flash memory cards, and digital video disks.

A number of program modules can be stored by the various storage devices and within RAM 67. Such program modules include an operating system 80, a directed advertising module 100, and a coupon redemption module 200. The directed advertising module 100 and coupon redemption module 200 control certain aspects of the operation of the directed advertising server 20, as can be described in more detail below, with the assistance of the processor 60 and an operating system 80. Also located within the directed advertising server 20 can be a network interface 74 for interfacing and communicating with other elements of a computer network. One or more of the directed advertising server 20 components can be located geographically remotely from other directed advertising server 20 components. Furthermore, one or more of the components can be combined, and additional components performing functions described herein can be included in the directed advertising server 20.

In an embodiment, a system having modules can be used. As noted above, various aspects of the system's functionality can be executed by certain system modules, including the system's directed advertising module 100 and coupon. In an embodiment, a directed advertising module can be used. In an embodiment, a redemption module 200 can be used.

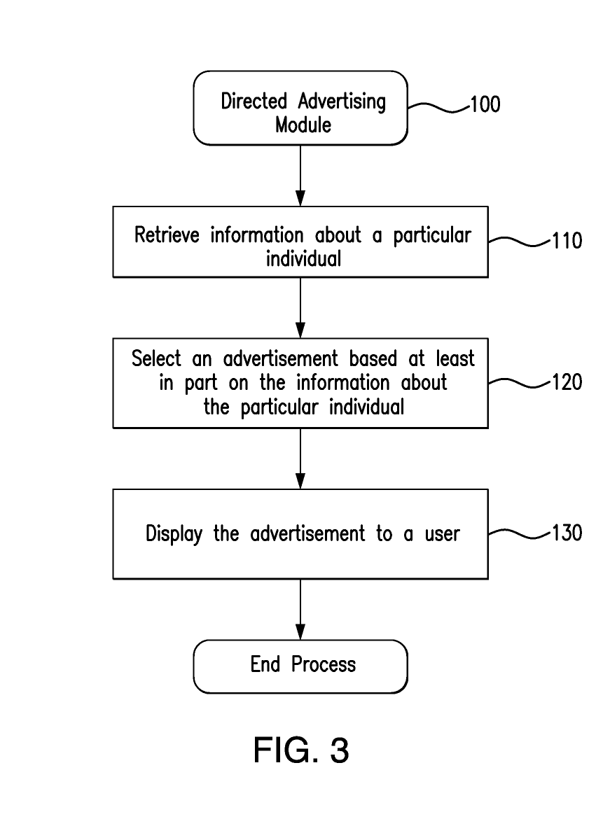

FIG. 3 can be a flow chart of an exemplary directed advertising module 100. As can be understood from this figure, certain embodiments of the directed advertising module 100 are configured to generate and/or direct advertisements to users of the directed advertising and educational information system based at least in part on information about the users. For example, as discussed above, the system can direct advertisements, including one or more special offers, to users based on education information stored within the system. Herein a directed advertising module 100 is a non-limiting example embodiment of a DAS.

In step 110, the system retrieves information about an individual (e.g, a user of the system, who can for example be a student, a relative of a student, or an educational institution employee). The system can retrieve this information, for example, from the educational information database 45. As discussed above, such information can include, for example, education information, such as a student's grade point average, current homework assignments, attendance information, calendar of activities, clubs, athletic or academic teams, and other interests. In addition, the system can retrieve general demographic information for the student, such as the student's age, gender and/or address.

It should be understood that the “user” of the system can, in some instances, be the student or the student's legal guardian. In embodiments, in step 110, the system can retrieve information both about a non-student user of the system and about a student affiliated with the user. For example, if a student's mother can be currently accessing the system, the system retrieves information regarding the mother (e.g., her gender, age, address, number of children and other relevant information), and also information about the student. As discussed below, such information can be used to select an appropriate advertisement for the user.

In step 120, the system selects an advertisement for the user, based at least in part on the information from the Educational Information Database 45. In various embodiments, the advertisement can be based, at least in part, on a student's educational information. For example, if the system determines that the user can be a student with a grade point average at or above 3.75, the system can display a coupon for a free e-book from an online bookseller. In other embodiments, the system can be configured to direct advertisements to students based on age, gender and/or any of the other factors discussed above. For example, all female high school students who are juniors or seniors can receive a coupon for 10% off of homecoming dresses at a local dress shop.

While the advertisements can be in the form of promotions and/or coupons that benefit the users directly, the advertisements can, for example, also result in a donation back to a school when the user redeems a coupon or otherwise accepts an offer. For example, an advertisement can indicate that a car dealership will donate $100 to the school when a user redeems a coupon at the car dealership.

In embodiments, advertisements or offers can include a guarantee that the company making the offer or placing the advertisement will make a donation to a school or other organization to which the user has an association and/or interest. For example, in the car dealership example above, the $100 donation that the car dealership promises to donate to the user's school can be the only benefit received from purchasing a car at the dealership (e.g., the user can not receive an additional discount on the car for claiming the offer). In such embodiments, users of offers can desire to benefit their school or other organization while making purchases that they already planned on making (e.g., the user can select a car dealership because that car dealership has promised to donate to their school). In step 130, the system then displays the selected advertisement to the user, for example, via an electronic display on a computer or mobile device, or via an electronic message, such as an e-mail or text message.

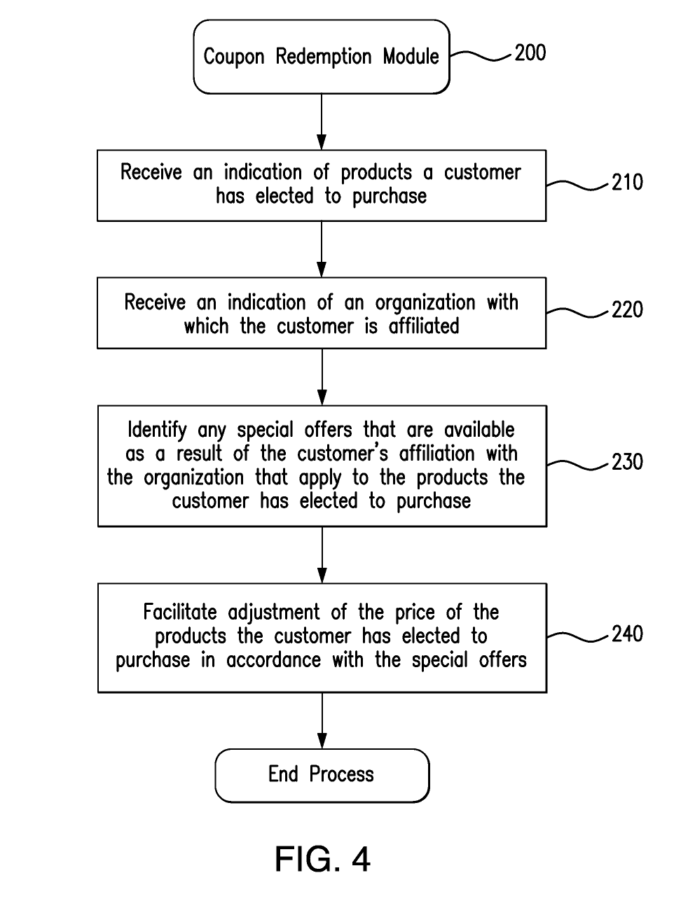

FIG. 4 can be a flow chart of an example of a coupon redemption module 200. In step 210, the system receives an indication of what products a customer has elected to purchase (e.g., at a retail location or on a web site).

In Step 220, the system receives an indication of an organization that the customer can be affiliated with.

In Step 230, the application identifies special offers that are available as a result of the customer's affiliation with the organization, and that apply to the items that the customer wishes to purchase.

Finally, in Step 240, the system facilitates adjusting the price of the purchased products to reflect the discount to which the customer can be entitled based on their association with the organization.

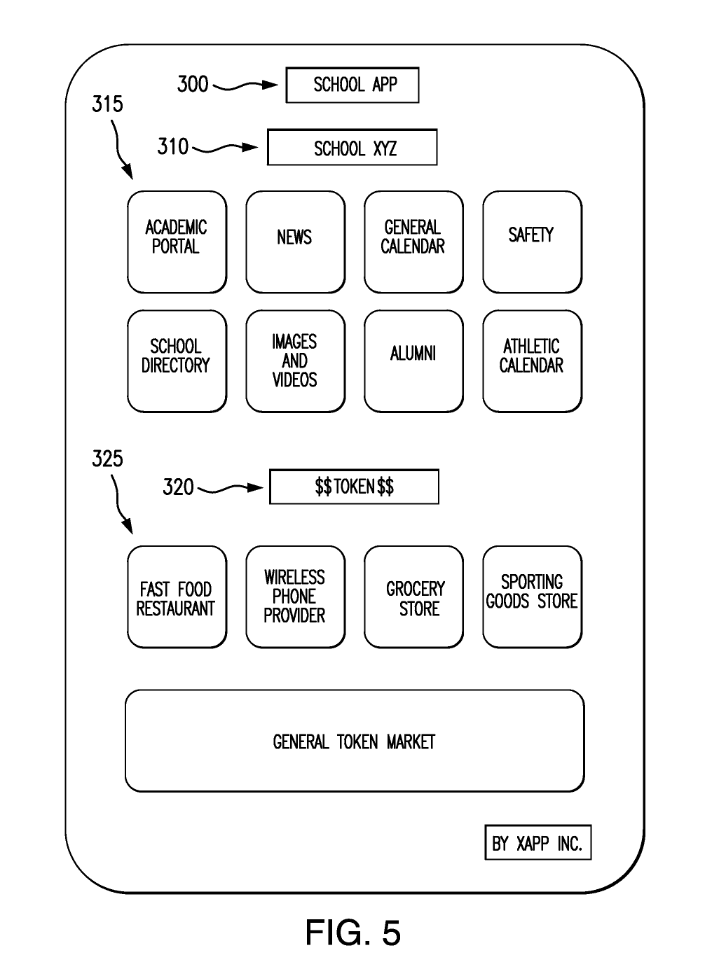

FIG. 5 illustrates an example of a user interface 300 for an embodiment of a directed advertising and educational information system 10. This figure represents the user interface 300 of an application running on a mobile device, but a similar interface can be used on tablet computers, desktop computers, laptops, and other similar devices. This interface 300 can be used by users to access various aspects of the system. In embodiments, the system can be adapted to facilitate communication between the wireless device and a central server that, for example, can store one or more of the databases discussed above.

In the embodiment shown in FIG. 5, the application home page can be divided into two sections. The top half contains an academic portion 310, while the bottom half displays a DAS Portion 320 (also as DAS, on in an embodiment DAS-TOKEN or TOKEN), which can, for example, include advertisements and other offers.

In the embodiment shown in FIG. 5, the Academic Portion 310 has eight tabs 315 that the user can access (e.g., via a touch screen of a mobile device). These eight tabs 315 include an Academic Portal, a News tab, a General Calendar, a Safety Tab, a School Directory Tab, an Images and Videos Tab, an Alumni Tab, and an Athletic Calendar. In the embodiment shown in FIG. 5, the DAS 320 has five tabs 325 that a user can access. These five tabs 325 include links 420 to different market categories as well as the general market. In embodiments, the academic portion 310 provides the user with access to some or all of the academic information referred to earlier in this document. Due to differences in screen size and graphical capabilities between computers and handheld devices, user interfaces can differ depending on the device that the user accesses the system. As mentioned earlier, a user interface such as the user interface shown in FIG. 5 can, for example, be particularly suitable for accessing the system via a tablet or smartphone.

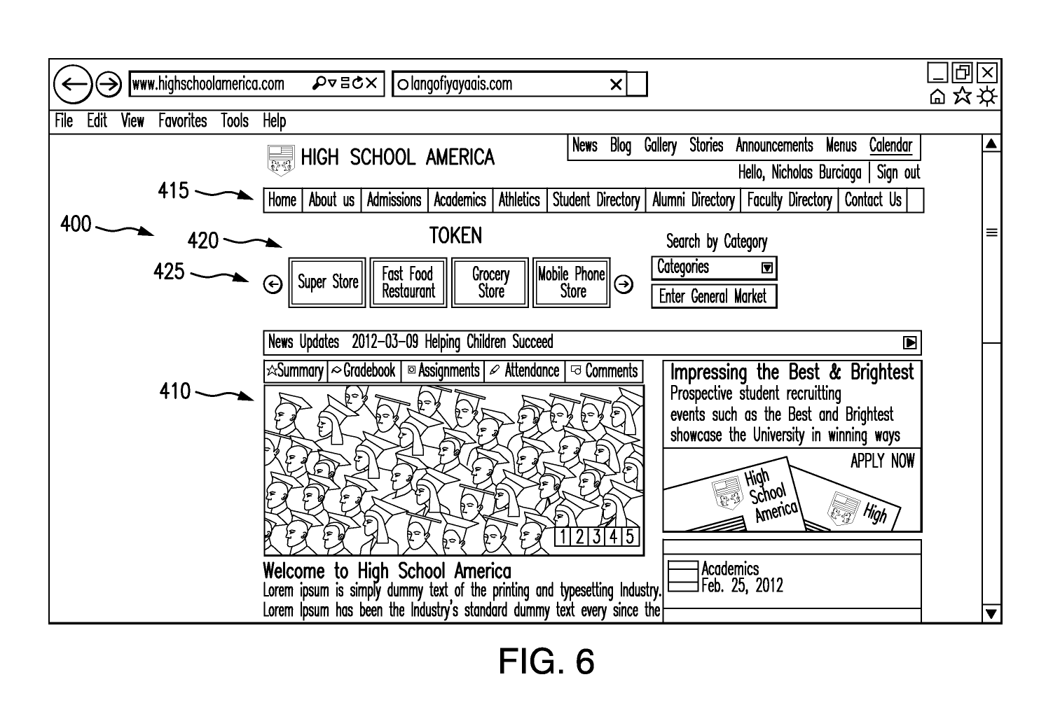

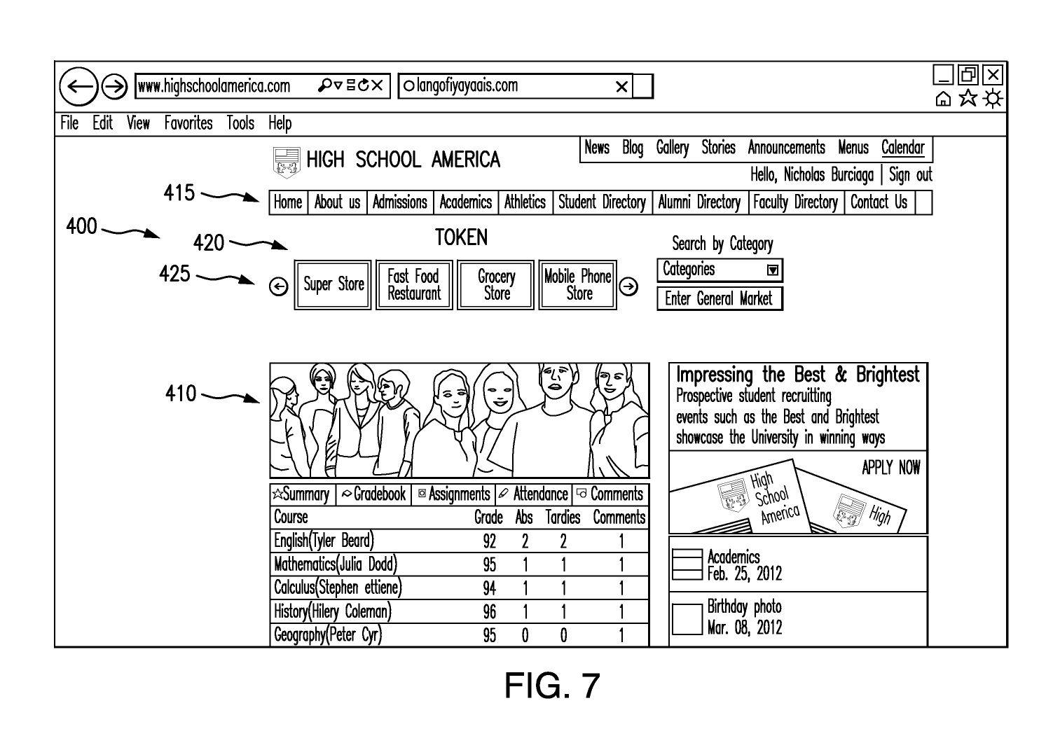

The embodiment shown in FIGS. 6-8 are screen displays of a user interface 400 according to another embodiment. As can be understood from FIGS. 6-8, these figures can represent a user interface 400 that can be adapted to be displayed on a personal computer (e.g., via a web browser or other suitable application). FIG. 6 illustrates an exemplary home screen of a user interface that includes an Academic Portion 410 and a DAS 420.

As can be understood from these figures, the academic portion 410 can include various tabs 415 that allow a user to access information (e.g., admissions information, academic information (e.g., a student's grades, homework assignments, attendance records, disciplinary reports, etc. . . . ), athletic information, a student directory, an alumni directory, and/or a faculty directory). In various embodiments, the DAS 420 can include links to advertisements, offers, rewards, and/or similar deals that are made available from companies (e.g., fast food restaurants, grocery stores, mobile phone providers, etc.). The system can generate and/or display advertisements on the user interface's DAS 420 based on any of the criteria discussed above (e.g., the system can display any advertisements, offers and/or discounts to the user based whether the user and/or individuals associated with the user qualify for those offers, which can be contingent on the user or other individual meeting requirements, such as membership in an organization and/or maintaining a certain grade point average.)

In embodiments, the user interface can have a “contact us” page and a campus map. Teachers and administrators can access the user interface to update and upload information and data (e.g., academic records of students). In various embodiments, students and parents can have constant access to view this data and information. Teachers, parents, students, and alumni can access all of the features described above via, for example, suitable user interfaces such as those shown in FIGS. 5-8. FIG. 5 displays a basic interface can be used to access the DAS and/or EIS via a wireless device. The following sections explain each button or tab, on the interface.

In embodiments, the Academic Portion can allow teachers and administrators to upload and update student course information, including class schedules, individual student grades, student attendance information, overall class grade averages, and teacher comments. In various embodiments, the Academic Portion can also include a general assignments page that can display current and future homework and classwork assignments along with the corresponding due dates and grades for each class. In such embodiments, the system can also allow students to submit assignments online to the teacher. In embodiments, each class can have a grade book that displays the student's overall average, the class average, grade distribution, and categories of assignments, such as tests, quizzes, reports, and homework. Information accessible via the specific tabs 315 displayed in FIG. 5 can be described below. The academic portion can include several other features designed to lower communication barriers between teachers and students, such as a discussion board, internal messaging system, conduct record, teacher and/or student comments, attendance, and other information relating to a student's academics.

In embodiments, a News section can include a streaming RSS feed that contains up-to-date news for a school. In various embodiments, this section contains general school news.

In embodiments, a General Calendar section can display a general school calendar that contains basic information such as school holidays, early dismissal days, the first and last days of school, and any information the school deems appropriate for the General Calendar.

In embodiments, a Safety section can display safety alerts. The school can use this section to post general alerts, and to send automatic mass text messages and e-mail messages to students and parents. The school can use this section, for example, to cancel or delay classes due to inclement weather or for any other reason. The Safety section can also include procedures for various “dangerous” situations (e.g., bomb threats, natural disasters, fires, etc.), and provide a direct way to speed dial police or campus security. In various embodiments, the school can post useful safety phone numbers in the Safety section, such as numbers for designated driver services, or a hazing or bullying hotline.

In embodiments, a School Directory section can contain contact information for students, parents, teachers, and alumni. In various embodiments, there can be a link to social media sites (e.g., Facebook, Twitter, etc.) that can be used to find and communicate with students, parents, teachers, and alumni, and to distribute “frenzy” coupons, which are discussed below.

In embodiments, an Alumni section can contain a link to join and/or renew alumni membership, a link to alumni discounts, a calendar of alumni events, a feature for finding alumni clubs, contact information for an alumni association, and/or any other information that can be of interest to an alumnus of an educational institution.

In embodiments, an Athletic Calendar section can include dates, times, and locations of one or more upcoming athletic events for an educational institution. In various embodiments, the Athletic Calendar section can include access to up-to-date scores from school athletic events and any other information related to school athletics (e.g., team records, individual statistics, etc.).

In embodiments, the DAS (also synonymous with “DAS Portion”) allows businesses to post advertisements, special offers, and/or coupons to the system for distribution and/or display to various users of the system (e.g., using the techniques discussed above). As shown in FIG. 5, the DAS can include tabs for primary corporate sponsors of the application. In various embodiments, the DAS can also contain a link to a “General DAS Market”. In embodiments, the “General DAS Market” can allow businesses to input specific deals, offers, and advertisements for distribution and/or display by the system, and to optionally specify the criteria that should be used in distributing/displaying the deals, offers and/or advertisements.

For example, the DAS can allow a sponsoring restaurant to indicate that they will provide a free chicken sandwich to any student who made a school's honor roll in a semester. The DAS can be configured to allow the sponsor (e.g., the restaurant) to upload graphics and other information to be used within an advertisement that includes the special offer. In an embodiment, when a user logs into the SIS, DAS and/or LMS system, the DAS determines whether the user or an individual related to the user qualifies for the offer (e.g., whether the user or any of the user's children made the school's honor roll in the indicated semester). If so, the system displays the offer to the user on the DAS's user interface screen. If not, the system does not display the offer to the user. The DAS can also be able to “push” out new offers to students who meet a set of predetermined criteria via email, internal messaging system, smartphone notification, or other method that can cause the user to quickly notice the new offer.

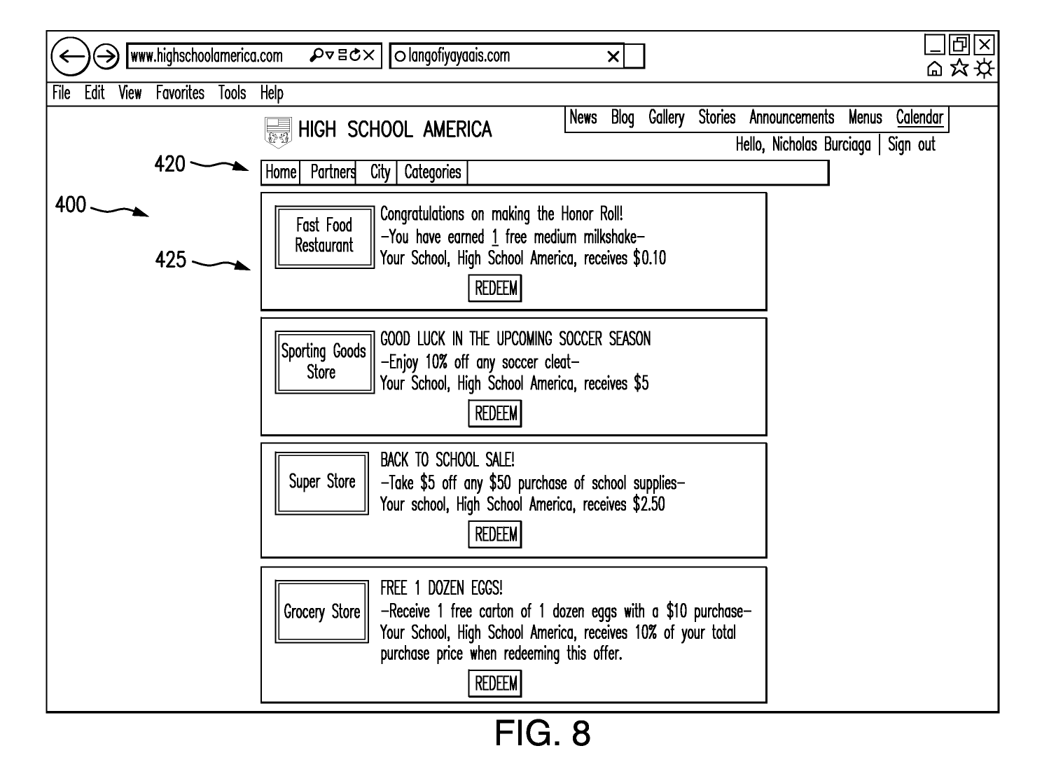

In various embodiments, the offers can include rewards for students (e.g., for academic performance). In embodiments, offers and advertisements can optionally include donations to be made by a sponsor to a specified educational institution if the user accepts an offer. For example, as shown in FIG. 8, an offer for 10% off of a soccer cleat at a sporting goods store can also specify that the store will make a $5 donation to a school when a student of the school redeems the offer.

In embodiments, each offer can include an amount of money or a percentage of the sale price that will be donated for the benefit of a specified educational institution if the user accepts the offer. In various embodiments, the amount of money (e.g., a specific amount such as $5.00 or a percentage of the price of items purchased when redeeming an offer) that will be donated to the educational institution can be displayed as part of the offer (e.g., such as the offers shown in FIG. 8). In such embodiments, the users can know the extent to which the educational institution will benefit when the user redeems the offer.

In various embodiments, when businesses post new advertisements or coupons, their corresponding tab can become highlighted, or the system can otherwise indicate to the user that a business has a new offer available.

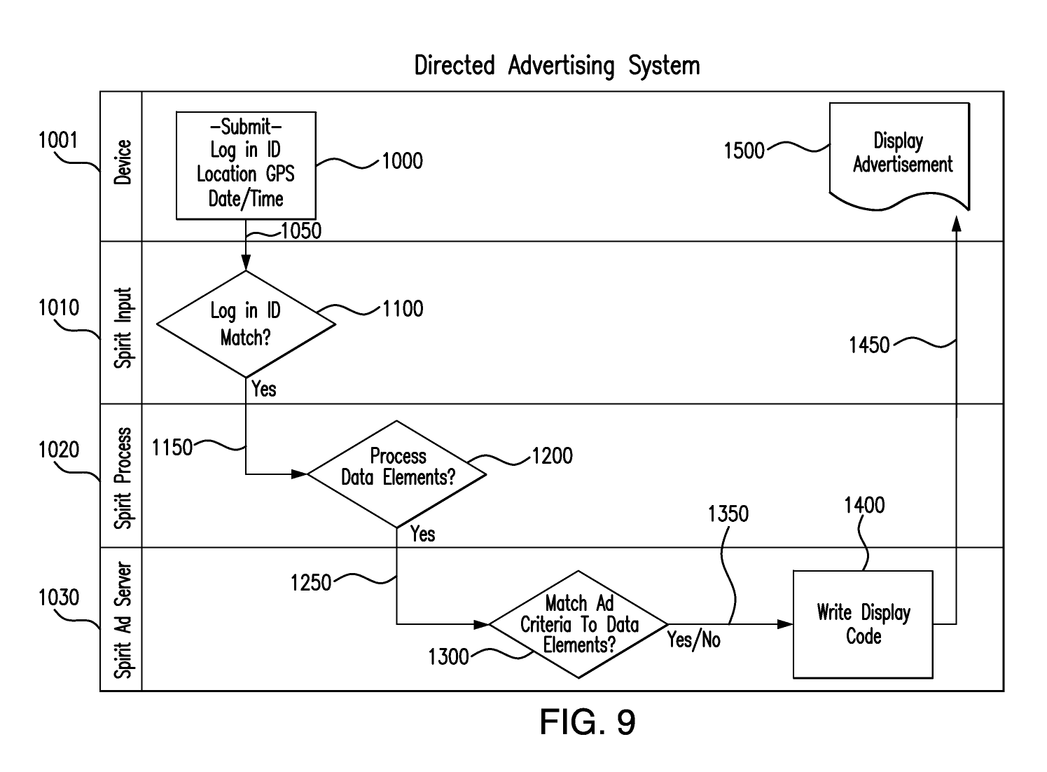

FIG. 9 is a rule-based logic flow diagram of an embodiment of a DAS. FIG. 9 depicts a method by which the DAS displays an advertisement to a device.

In this example of FIG. 9 the device 1001 contains data elements 1000. The data elements can have a log-in ID, a location or GPS location, and/or a date/time. In Step 1050 the data elements are sent from the device to the spirit input system 1010. In Step 1100 the spirit input system executes a rule-based logic to determine if the log-in ID is a match. In Step 1200 the spirit system 1020 can process the data elements and send them to the spirit advertisement server 1030. The spirit advertisement server can match advertisement criteria to the data elements in Step 1300 and write display code for the corresponding device and advertisement in Step 1400. This is communicated to the device in Step 1450 and displayed on the device in Step 1500.

In Steps 1150, 1250, and 1350, the DAS passes along data elements according to a rule-based logic. In Step 1150 this data must satisfy the rule of a matching log-in ID. In Steps 1250 and 1350, this data is used to determine the correct advertisement to be shown.

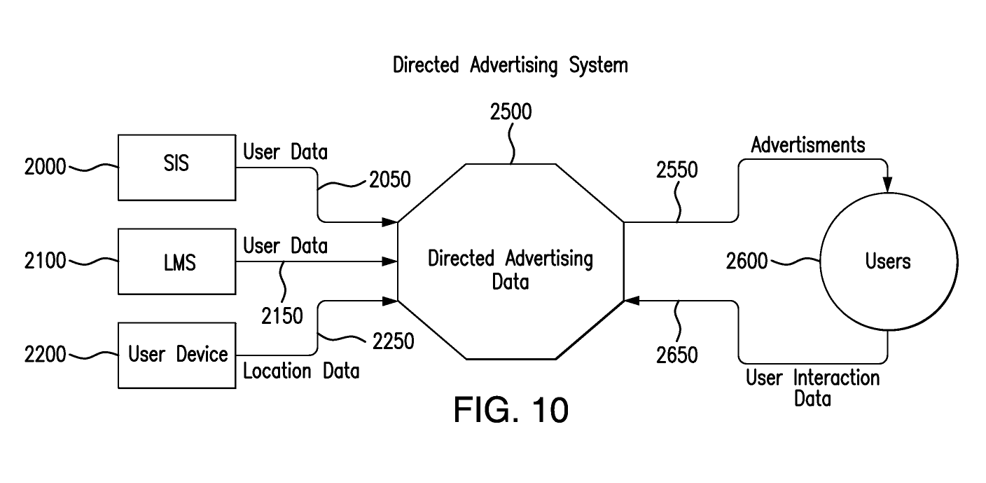

FIG. 10 is a data flow diagram of an embodiment of a DAS; FIG. 10 depicts a Student Information System (SIS) 2000, a Learning Management System (LMS) 2100, a user device 2200, a system to process directed advertising data 2500, and users 2600.

In Steps 2050, 2150, and 22250, the SIS, LMS, and User Device, respectively communicate user data to the system that can process the Directed Advertising Data. In Step 2550, the DAS data communicates advertisements to the users. Data about the user interactions is then sent back to be processed as directed advertising data in Step 2650.

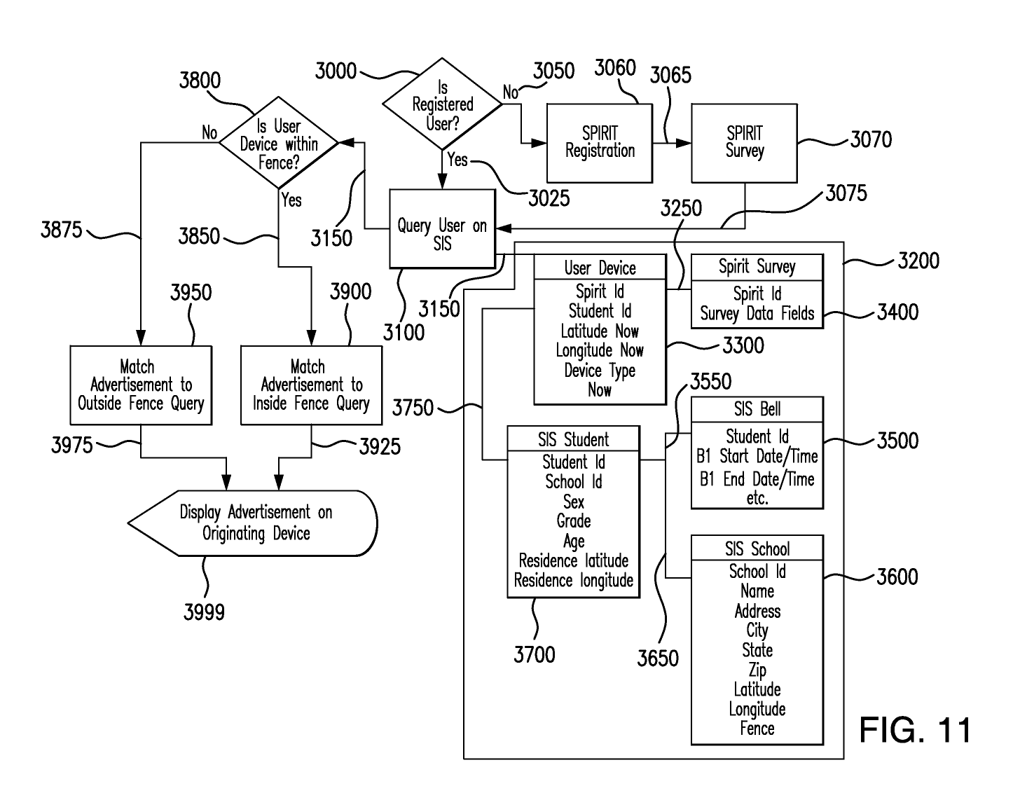

FIG. 11 is a combined rule-based logic flow diagram and data flow diagram of an embodiment of a DAS; FIG. 11 depicts a process by which a user is shown an advertisement.

In Step 3000, the DAS determines if the user is a registered user, if the user is a registered user, then this is communicated to the DAS in Step 3025. If the user is not a registered user, then they are sent to the Spirit registration in Step 3050. In Step 3060, the user registers for Spirit. They are then sent to the Spirit Survey in Step 3065. In Step 3070, the user completes the Spirit Survey and the data is sent to the DAS in Step 3075 to be used to select an Advertisement.

In Step 3100, the DAS receives user data from a SIS. This data is sent to the DAS in Step 3150. In Step 3800, the DAS processes User Device Data to determine if they are located within a predetermined “Fence” area. If the user device is not within the fence, data is processed in Step 3875, an advertisement match is selected in Step 3950, and the selected advertisement is sent to the originating device in Step 3975. If the user device is within the fence, data is processed in Step 3850, an advertisement match is selected in Step 3900, and the selected advertisement is sent to the originating device in Step 3925. In Step 3999 the selected advertisement is displayed on the originating device.

Section 3200 illustrates the types of user data that can be accessed by the DAS. Section 3300 illustrates different types of user device data. Section 3400 illustrates different types of Spirit survey data. Section 3500 illustrates different types of SIS bell data. Section 3600 illustrates different types of SIS school data. Section 3700 illustrates different types of SIS student data. Step 3250 illustrates the relationship between the user device data and Spirit survey data in that for a given user they will have the same Spirit ID. Step 3750 illustrates the relationship between the user device data and SIS student data in that for a given user they will have the same student id. Step 3550 illustrates the relationship between the SIS student data and SIS bell data in that for a given user they will have the same student ID. Step 3650 illustrates the relationship between the SIS student data and SIS school data in that for a given user they will have the same school ID.

In embodiments, the system can be configured to allow businesses to post “frenzy” coupons to the DAS of the web and mobile applications. Frenzy coupons can require a number of users to activate them before they become redeemable. For example, a coupon for 10% off at a grocery store can require 20 users to activate the coupon before any users can redeem the coupon. Frenzy coupons can result in higher discounts than, for example, a traditional coupon that does not require a minimum number of users to activate it before the coupon becomes usable. In various embodiments, users can “spread the word” about frenzy coupons through social media applications, such as Facebook and/or Twitter.

In an embodiment, advertisements can be communicated to people associated with a student. As discussed above, the system can direct advertisements to people associated with a student (e.g., the student's parents, grandparents, guardians, etc.) Sometimes, the students are not the true target market of the advertisement. For example, orthodontists' patients are teenagers or children. However, parents are typically the decision makers who actually pay for orthodontic treatment. Therefore, parents can be the actual target market for a business. This type of advertising can be further categorized to people associated with students within an age range, such as offering coupons for discounts at a car dealership to parents of children turning 16 years old.

In an embodiment, advertisements can be directed toward other persons associated with a school. Some embodiments can include directed advertisements for others associated with the school (e.g., school teachers, alumni, faculty, and administrators). The advertisements can be directed, for example, based on the user's association with the school (e.g., school supply discounts for teachers, etc.)

In some embodiments, pre-purchase coupons can be communicated by the DAS. Users can purchase some offers directly from their computer or mobile device. After purchasing said offer, users can be provided with a barcode or other method of indicating their purchase to a participating business that can be printable from a computer or which can be scanned from the screen of a mobile device. Users can then be able to redeem their proof of purchase for the item in the offer. The system can log the coupon as having been purchased as soon as the user completes the transaction from their computer or mobile device.

In an embodiment, direct donation coupons can be offered by the DAS. Businesses can display coupons to users that offer to donate a set amount of money to a user's educational institution if the user completes a qualifying purchase at the business. Users can view these coupons and then have the business enter verification of the purchase upon completion in order to track the donations that the business can make to the school. Upon verification by the business on the user's mobile device, the system can log the offer as having been redeemed.

In an embodiment, in store coupons can be communicated by the DAS. Users can be presented with some coupons that can only be redeemed within a place of business. These coupons can be redeemed when users perform an action on a mobile device that indicates they want to redeem said coupon. When the users indicate that they want to redeem the coupon, the system can use GPS technology to confirm that the user can be at the place of business for the coupon that they want to redeem. Once this confirmation has been completed, the system can log the coupon as having been redeemed. The user can then be presented with a method of proof on their mobile device that can allow the merchant to apply the appropriate discount to their purchase.

Examples include hamburger coupons to football players, nail salon coupons to cheerleaders, ice cream coupons to all students in 5^{th} a grade or lower, orthodontist coupons to the parents of students in grades 1-6, and Barnes and Noble book coupons to every student who made an “A” in English.

In an embodiment, the DAS can provide frenzy advertising. In an embodiment, the method can have one, more or all of the following steps: a method of advertising, having the steps of: Providing one or more types of user data, providing an advertising data which has data for a frenzy coupon; providing a merchant data; providing a frenzy coupon data, providing a minimum user quota; communicating frenzy coupon data to users; allowing users to indicate their desire to redeem the frenzy coupon via mobile device; providing a frenzy value; providing a first frenzy feedback data to users prior to attaining a frenzy value; proving a second frenzy feedback data to users prior to attaining a frenzy value; providing a graphical user interface which has a visual depiction of the status of coupon purchases in relation to the frenzy value; providing information to users that the minimum user quota has been exceeded when a great enough number of users within the same GPS location as the merchant have indicated their desire to redeem the frenzy coupon, and redemption of the frenzy coupons.

This embodiment can has a combination of different types of user data (directory, survey, purchase history, etc). In an embodiment a minimum quota of users in one GPS location can unlock a deal. In an embodiment, the methods, computer systems and software disclosed herein can have, use and has user data which can be FERPA “Directory” data. Directory information can be data within the SIS database that schools are allowed to share.

Directory information can has one, more or all of the following: student's full name; permanent address and telephone number; local address and telephone number; e-mail address; state of residence; date and place of birth; marital status; academic status; class schedule and roster; name of advisor; major field of study (including the college, division, department or program in which the student can be enrolled); participation in officially recognized activities & sports; participation in hobbies or sports or activities unaffiliated with the school; weight and height of members of athletic teams; dates of attendance and graduation; degrees and honors & awards received (including selection to a dean's list or honorary organization and the grade point average of students selected, and the most previous educational institution attended); and photographic, video, or electronic images of students taken and maintained by the university.

In an embodiment, the methods, computer systems and software disclosed herein can have, use and comprise user data which can be data from a user survey. In an embodiment, the methods, computer systems and software disclosed herein can have, use and comprise user data which can be purchase history data. In an embodiment, the methods, computer systems and software disclosed herein can have, use and comprise user data which can be social media data. In an embodiment, the methods, computer systems and software disclosed herein can have, use and comprise user data which can be behavioral data. In an embodiment, the methods, computer systems and software disclosed herein can have, use and comprise user data which can be student information data. In an embodiment, the methods, computer systems and software disclosed herein can have, use and comprise user data which can be school calendar data. In an embodiment, the methods, computer systems and software disclosed herein can have, use and comprise user data which can be academic performance data. In an embodiment, the methods, computer systems and software disclosed herein can have, use and comprise user data which can be conduct data. In an embodiment, the methods, computer systems and software disclosed herein can have, use and comprise user data which can be attendance data. In an embodiment, the methods, computer systems and software disclosed herein can have, use and comprise user data which can be assignment data. In an embodiment, the methods, computer systems and software disclosed herein can have, use and comprise user data which can be GPS data. In an embodiment, the methods, computer systems and software disclosed herein can have, use and comprise user data which can be school announcement data. In an embodiment, the methods, computer systems and software disclosed herein can have, use and comprise user data which can be safety/weather alert data.

In an embodiment, the method can have one, more or all of the following steps: a method of data analytics, such as: providing a SIS; providing academic data regarding a student; providing behavioral data regarding a student. In an embodiment, a combination of behavioral data such as time of activity and location of activities, participants in an activity or any other data associated with an activity or one or more individuals associated, participating and/or interested in an activity can be processed.

In an embodiment, the methods, computer systems and software disclosed herein can have, use and comprise academic data which can be a performance data. In an embodiment, the methods, computer systems and software disclosed herein can have, use and comprise behavioral data which can be time of activity data. In an embodiment, the methods, computer systems and software disclosed herein can have, use and comprise behavioral data which can be a product or service purchase information. In an embodiment, the methods, computer systems and software disclosed herein can have, use and comprise behavioral data which can be a keyword data. In an embodiment, the methods, computer systems and software disclosed herein can have, use and comprise behavioral data which can be a data from a social media source. In an embodiment, the methods, computer systems and software disclosed herein can have, use and comprise behavioral data which can be a data from the student information. In an embodiment, the methods, computer systems and sofhware disclosed herein can have, use and comprise behavioral data which can be a student assignment submission data. In an embodiment, the methods, computer systems and software disclosed herein can have, use and comprise one or more types of user data. In an embodiment, the methods, computer systems and software disclosed herein can have, use and comprise user data which can be FERPA “Directory” data.

In an embodiment, the DAS can utilize information sourced, from or present in social media. In an embodiment, the student in formation system, computer system, software and program readable code and products disclosed herein can comprise and/or have one or more, or all, of the following: a SIS, comprising: a student data which can be input into the SIS by a user; a social media data which input into the student information system resulting from a social media source; computer readable program code which executes rule-based logic which compares the student data and the social media data to an advertising criteria to identify an advertising match; and computer readable program code which generates an electronic communication of an advertisement based upon the advertising match. In an embodiment, the student information system, software and/or methods can use a combination of social media data with data from SIS

In an embodiment, the computer systems, student information systems and software disclosed herein can have social media data which can be a social media event. In an embodiment, the computer systems, student information systems and software disclosed herein can have student data and social media data which are combined with other user data.

In an embodiment, the SIS, computer system, software and program readable code and products disclosed herein can be used by the DAS and/or SIS. Data can regard academic needs and requirements as determined by school covenants, student needs and/or wants, or class specific activities, and can be populated with goods and/or services provided by parents and/or associated companies. The DAS can use, have and/or comprise student data of a SIS; student data of FERPA; student data from one or more surveys; student data of a school calendar; student data of a to-do list, student location data, student data of academic performance; student data of an assignment; data regarding a good; goods including school or academic specific items encompassing uniforms, project materials, and spirit-related merchandise; the data regarding present in an electronic marketplace database; a marketing criteria based upon the data wherein good are identified and related to data items; advertising data based upon the data wherein good are identified and related to data items. There is no limit to the data which can be used or processed by the DAS. There is also no limitation to the source of any data used by the DAS (e.g. SIS or other system or source of information and/or data).

In an embodiment, when purchases are made of goods based on the data, the record of the sales are posted as data to the purchase history to be used for future matching and promotion. Optionally, purchases can be processed through a standard online shopping and payments made through exiting payment gateways.

In an embodiment, the method can have and/or comprise one, more or all of the following steps: providing a merchant access to a DAS; the DAS receiving school data, location data and receiving student data; the merchant defining a target market; relating the geographical region and a school district; providing a merchant input data regarding the school district; providing a merchant input data regarding an advertisement; providing a SIS having data regarding a school event; the SIS providing a student interest data; providing a match criteria for matching a student to the advertisement based upon the school event data and the student interest data processing the student interest data and the school event data to determine a one matching student or a plurality of matching students having a match; sending the advertisement to the one matching student or the plurality of matching students.

In an embodiment, a combination of directory data can be used with school event, student interest, and relationship data to select users for an advertisement. In an embodiment, parents, administrators, and teachers can have their data included as well. This match can be determined by the relationship between parents, teachers, students, and administrators.

In an embodiment the system and methods herein, can optionally reduce the number of ads shown to students who would otherwise be included in a query. In a non-limiting Example, an ice cream shop wants to advertise to students when ALL of the following conditions are TRUE: (1) Student District=Floyd County School District (total pool≦800); and (2) School Event=Football (total pool=800); and (3) School Event=TODAY (total pool=800), and (4) Student Sport=Football (total pool=35). Therefore, in this example, in a total pool of 800 users only 35 users would see the advertisement. AND to further lower the cost to the advertiser, the advertisement will ONLY run on the DAY of the EVENT.

In another example, a restaurant wants to advertise to students who play football and are in the Floyd County School District on a football game day. While there might be 800 students in this school district on the day of a football game, only 35 of the students play football. Conforming to this requirement, the DAS can send the restaurant advertising information to the students that played football.

In an embodiment, the advertisers cost can be reduced. In an embodiment, the Advertiser has the ability to qualify their target group to an ever shrinking pool.

In an embodiment, the method can comprise one, more or all of the following steps: a method for directed advertising, comprising: providing a target market criteria; providing a SIS containing “directory data” about students and teachers; Students, parents, administrators, and/or teachers authorizing the use of the directory data from the SIS through a graphical user interface; Students, parents, administrators, and/or teachers entering additional marketing data into the system via a survey on a graphical user interface; executing computer-readable code to determine if a student, parent, administrator, and/or teacher can be a match by comparing the directory data and additional marketing data with the target market criteria; displaying advertisement to the student, parent, administrator, and/or teacher via electronic means if the user directory and/or marketing data matches the target marketing criteria. In an embodiment, a combination of survey data can be used having directory data that has been authorized for use by the teacher, student, or parent. In an embodiment marketing data can be a type of survey data.

In an embodiment, the methods, computer systems and software disclosed herein can have, use and comprise a step in which the directory data and the additional marketing data are combined with user data to determine a match to the target market criteria

In an embodiment, the method can comprise one, more or all of the following steps: a method for directed advertising, comprising: providing a merchant data; proving an advertising data; providing a DAS; the DAS executes rule-based logic querying a merchant user to a deal; the deal accounting for a value designation as allocated to a school based on an amount of the deal; the merchant executing a decision which electronically pushes the deal to users of the directed advertising system; the user presenting a visual data regarding the deal to the merchant at the point of sale; the data regarding the deal can be processed at the point of sale executing the deal; and the directed advertising system calculating the value designated as allocated to the school when the deal can be executed.

In an embodiment, the SIS, computer system, software and program readable code and products disclosed herein can comprise and/or have one or more, or all, of the following: a data of a class recorded in the SIS: the SIS comprising data uploaded by an authorized user; the authorized user being a teacher of the class; the data comprising academic content for the class.

Directed advertising and educational information systems according to embodiments include an academic portion and a DAS. In various embodiments, the academic portion can be configured to display location and educational information to a user. The educational information can include grade information, information about homework assignments, school news, and other information. In various embodiments, the DAS is configured to display offers to the user based at least in part on the location and/or other educational information.

The DAS offers an advertiser the chance to select aggregate groups of users as targeted users. In one particular embodiment, an advertiser selects football players as the target market criteria. The DAS then shows the advertisement to any user who is a member of the football team. This protects the privacy of users by only allowing merchants to see the aggregate data of different student groups. The advertiser can also choose to target market based on relationships to targeted users. In one embodiment, an advertiser selects football players and their parents as the target market criteria. The DAS then shows the advertisement to any user who is a member of the football team or who is the parent of a member of the football team.

The DAS also applies target marketing data based upon the results of a survey shown to students, parents, and faculty. The DAS also protects student records by only allowing advertisers to see aggregate data and not the psychological information of any individual user. The DAS can allow advertisers to view data about which users have redeemed an offer.

An SIS can process the location and time of a particular class. The DAS and/or SIS can process different categories of student grades. In an embodiment, the DAS allows merchants to compare target market data vs. redemption of offers to determine success of various criteria. Advertisers can also use behavioral and purchase history data along with academic performance to determine marketing tendencies. In one embodiment, an advertiser can compare aggregate food purchase history data with academic performance data to determine what types of food are typically consumed by higher-performing students. These users can then be targeted for advertisements based upon not only their dietary preferences, but also the dietary habits of similarly-performing students when they enter a grocery store. In another embodiment, an advertiser can compare behavioral data with purchase history data to determine if students that stay up late prefer different types of food. Advertisers can also compare this data with student interest data and various other types of user data.

The DAS can combine data from social media with other student data and school data. In one embodiment, an advertiser wishes to send an offer to all of the girls on the softball team when they win a game. The DAS knows the date of the softball team's games as well as the roster of girls on the team. When one of the girls on the roster makes a social media post with a keyword such as “victory” on a day when the softball team has a game, the advertisement can be shown to all of the girls on the softball team.

The DAS can combine data from social media with other student data and school data. In one embodiment, an advertiser wishes to send an offer to all of the girls on the softball team at the conclusion of the game for a discounted post-game meal at their restaurant. The DAS knows the date of the softball team's games as well as the roster of girls on the team. When the device location of one of the girls on the team indicates that the girl is within one mile of the restaurant, the system can push the advertisement for the discounted meal to all of the girls on the team as well as their parents and coaches. In this embodiment, a user must meet the location criteria of being within one mile of the restaurant, as well as the selection criteria of being a student, parent or coach of the softball team in order to receive the advertisement.

### Example 1

In an example, the DAS can be a method executed on a computer for directed advertising, in which said directed advertising system is adapted to process a data from a student information system. A input can be provided to said memory a school selection criteria comprising a geographic criteria, e.g. a school selection criteria selecting schools within a distance from a location, fence, point, event, person, business or other criteria, e.g. schools within one hundred miles (100 ml) of zip code 30161.

In this example such analysis can be achieved by providing to the memory a school geographic data which is an attribute of a school, such as a location, street address, geographic coordinates, GPS coordinates, latitude and longitude or other geographical indicator, e.g. the latitude and longitude of Marietta High School in Georgia.

Based upon this information, the computer can run a program executable code of a rule-based logic to determine whether a given school's geographic data satisfies said school selection criteria. For non-limiting example, the computer can calculate based upon latitude and longitude data of Marrietta High School whether that school is within 100 miles of zip code 30161.

In this example, if said school geographic data satisfies said school selection criteria, then said computer executes program executable code identifying said school as a matching school, e.g. Marietta High School is identified a matching school because it is within 100 miles of zip code 30161.

The DAS can provide to said memory a school data of said matching school from said SIS of said matching school. The SIS data provided to the DAS can be any data the SIS contains and/or data which is based upon, derived from or results from processing data in the SIS memory or otherwise contained in, originating with or processed by the SIS. In non-limiting example, said school data can comprising a first student data, such as bibliographic information about student John Smith of Marietta High School, such as name, address, phone, age, and other identifying information or other student information of the SIS.

The DAS can use the SIS data to determine whether a student, school or other person or thing meets one or more target market criteria. In this example, a target market criteria can be provided to the DAS, e.g. a target market criteria that a target market candidate be at least 16 years of age.

The DAS can run executable code of a rule-based logic to determine whether said first student data satisfies said first target market criteria, e.g. the computer can determine whether or not John Smith is at least 16 years of age.

If said first student data satisfies said first target market criteria, then said computer can execute program executable code identifying said student as a matching target candidate. In this non-limiting example, if John Smith is at least 16 years of age, then the computer can identify John Smith a marketing target candidate. There is no limit to the number and/or type of target market criteria that can be used in the DAS analysis to determine marketing target candidates.

To this point, in this non-limiting example a second target market criteria can be used, such as that a marketing candidate be currently located within one mil (1 m) of the Cobb County Mall at 400 Ernest W Barrett Pkwy NW Kennesaw, Ga.

The computer can make such a determination by processing a device data provided to the DAS of a matching target candidate device, such as for non-limiting example John Smith's smartphone phone. The device data can have for example a device location data. Thus, in this example John Smith's smartphone can provide GPS data regarding the location of the device, as well as presumably John Smith if he is proximate to the phone's vicinity. The DAS can use this information to run a program executable code of a rule-based logic to determine whether said device location data satisfies said second target market criteria. In this example, the DAS can calculate whether if John Smith's phone is currently located within 1 mile of Cobb County Mall.

If the device location data satisfies the second target market criteria, then said computer can execute program executable code identifying said device as a matching device. In this example, the circumstance if John Smith's smartphone is within 1 mile of Cobb County Mall, then the device will be identified as a matching device. For this example, the device is a matching device and is within 1 mile of Cobb County Mall.

The DAS can run a program executable code of a rule-based logic which identifies a matching device as a candidate device when the matching device is associated with a matching target candidate. Thus, in this non-limiting example John Smith's smartphone is a matching device and is identified by the DAS as a matching device because it is identified with John Smith who is identified as a matching target candidate.

In this example, an advertising criterion and/or criteria can be input or otherwise processed by the DAS to determine whether an advertising data should be sent to the matching device. In non-limiting example, the advertising criteria can be that the advertising data is to be sent to an individual who is a male. This criterion and/or criteria can be tested by providing to said memory a second student data from said SIS; such as a data from the SIS that John Smith has an attribute of being a male.

The computer can run a program executable code of a rule-based logic to determine whether said second student data matches said advertising criteria, such as whether John Smith is a male.

If said second student data satisfies said advertising criteria, then said computer executes program executable code identifying said matching device as a target device. For example, because John Smith is a male, then John Smith's smartphone is identified by the DAS as a target device.

The DAS can run program executable code and is adapted to electronically communicate an advertising data to a target device. In this non-limiting example, the DAS can communicate an advertising message to John Smith's smartphone, such as an advertisement for athletic equipment such as a sports shoe.

Thus, the DAS can run a program executable code electronically providing said advertising data to said target device. In this example, the DAS can electronically communicate an advertising data regarding a sports shoe advertisement to John Smith's smartphone.

Advertisers can use user preference data to target advertisements. This user preference data can be captured through a survey in the SIS or from past purchase history and/or histories. This data can be combined with other types of user data. In one embodiment, the DAS can present a user with a food advertisement based upon the types of tfood they have indicated that they like as well as what food items that have purchased in the past. The advertisement can also be tailored based upon other types of user data such as the user's zip code.

### Example 2

In one non-limiting example, it is 9:00 on a Friday night in September, and Adam, the CEO of Adam's Burger Shack, knows that thousands of high school football games all over America are about to be ending. Adam wants to ensure that many of those high school football teams have their post-game meals at his restaurants that night. Adam likes to use his promotions budget very efficiently and likes promotions that have a high usage rate. Adam has experienced a drop off in revenue in his two highest grossing counties, X County, Georgia and Y County, FL, and Adam's goal is to come up with a creative and efficient promotion to increase revenue in those two counties, which each have 10 of his restaurants. To accomplish his goal, Adam logs into the Adam's Burger Shack, DAS, e.g. DAS account which he has through his partnership with Lexalutions. After he logs in, he sees a menu of all 50 U.S. states and selects Georgia and Florida. He then selects X County School District in Georgia and Y County School District in Florida. He then selects football players, parents of football players, cheerleaders, parents of cheerleaders, football coaches, and children of football coaches. The DAS then automatically places all of these selected groups of people into a single group. Adam then creates a digital 50%-off cheeseburger coupon that reads “after the football game, come to a local Adam's Burger Shack and get 50% off a cheeseburger combo meal.” Optionally, Adam can also design the coupon so that a portion of every dollar generated by the promotion will go back to each user's individual school. The DAS pushes Adam's newly created digital coupon out to all the mobile phones of every member of Adam's newly created group. And, in real time, as the football games in X County School District and Y County School District are ending, all the football players, football patents, cheerleaders, cheerleader parents, coaches, and coaches' children in X County and Y County receive 50% off cheeseburger coupons to their mobile devices and other electronic devices to use after their football games for their post-game meals. In this example, Adam′ Burger Shack gets a huge influx of customers into his stores; and all of these people get a discount on their meals; and each of the individual schools in the two school districts receive revenue.

### Example 3

In some embodiments, users earn “Spirit Points” for redeeming a deal and/or completing an offer. These points represent and track the amount of money a user's use of the system has generated for the user's school (e.g. 100 points equals $1; 50,000 points means the user has generated $500 for their school).

For example Jim owns many shoe stores across the country. He wants to boost sales of the latest Nike running shoe, particularly in Arizona and New Mexico since one of his competitors recently opened several stores in this area. It is October, so he knows that many basketball players and wrestlers will be purchasing new running shoes to get in shape for their upcoming seasons. In the same process described in example 1, Jim logs into the DAS and selects several school districts in Arizona and New Mexico that are near his stores. He then creates a deal to pre-pay for the latest pair of Nike running shoes online through the DAS and the purchaser will only pay $59.99 rather than $69.99. He then selects to push this deal out to all the basketball players and wrestlers at the predetermined school districts as well as their parents. These students can now save $10 by purchasing the shoes through DAS and printing out a confirmation that can be brought into Jim's stores and exchanged for a pair of the Nike shoes. Optionally, users can also be notified that they will earn 100 spirit points for their school by purchasing the shoes through the DAS that will be converted into a donation from Jim's business specifically for the basketball/wrestling team.

In an alternative embodiment of the above example, Jim owns bookstores rather than shoe stores. Jim knows that students in 9th grade English class will soon be reading The Great Gatsby since it is listed on their assignments schedule for next week. He can then push out a pre-pay deal to all of the students in this English class to buy the book online through the DAS and pick it up at the store and pay only $8.99 rather than $10.99.

### Example 4

In one example, Carl owns a car dealership in Bethesda, Md. He wants to boost car sales using the SIS and/or DAS. He logs into the DAS and creates a Direct Donation deal saying that anyone for everyone (where purchasing for themselves or for someone else) who purchases a car from his dealership, he will donate $100 to their corresponding school system. Optionally, one who purchases a car from him will earn 2000 spirit points for their school. These spirit points can be totaled and converted to a monetary amount to be donated by Carl to each school at the end of each billing period. Carl selects several schools in Montgomery County to push out his deal to all of the high school students and parents. Julie, a mother of a child at Whitman High School, decides she wants to purchase a new SUV. She sees the direct donation deal on the DAS and decides to visit Carl's dealership. After deciding to purchase a new SUV, Julie presents her phone screen showing the deal to Carl's employee. Carl's employee enters a code on Julie's phone confirming that she has indeed purchased a car from the dealership, $100 and 2000 spirit points are earned tor Whitman High School.

The above deal example can also be targeted to a specific group of students or parents. A car dealership, for instance, might want to only push out this deal to parents of students who are about to turn 16 in hopes that they purchase a new car for their child on their birthday.

### Example 5

In an embodiment the DAS and/or SIS can process donations. In another embodiment, the DAS can display a link or offer to the user based upon behavioral data such as time of activity. A user that has been continuously logged on to the DAS and/or SIS system from 10 p.m. to 1 a.m. can be presented with a coffee coupon for a study break.

In one embodiment, targeted advertisements can be inserted within course content at key points to suggest study breaks and related offers (i.e. “Now that you have reviewed the Civil War, consider purchasing the Princeton Review guide to Reconstruction. Visit princetonreview.com in the next 24 hours and enter offer code SIS-Lex Guide Reconstruction” to get 25% off and free shipping!”; or “Whew, that was a tough section on Differential Equations. Your mind can definitely use a break. Treat yourself to a cup of coffee and Starbucks and show this guide to get $1 off any drink”). This system can allow for very targeted advertisements to be created and displayed to users at a fairly certain point in time. For example, if we know that a user, Suzy, created a guide for 6 hours' worth of studying before each of her first two Biology tests and spent time looking at the SIS/LMS from 6 p.m. to 1 a.m. the day before each test, then it is likely she will do the same for her third test. If Suzy logs into the SIS and/or LMS system at noon and requests that this guide be created the day before her third Biology test, she can be presented with a Starbucks offer specialized to her and only valid that evening. If Suzy has a history of shopping at Starbucks and completes a relatively high percentage of the targeted offers that are presented to her, then by placing this Starbucks offer halfway through her study guide, we can reasonably predict that Suzy will visit Starbucks between 9 and 10 μm that night as a study break for her test.

### Example 6

In some embodiments, users can earn rewards points for interactions with the SIS and DAS. In one example, a student that makes a 90% or higher on an English assignment can for example be rewarded with 100 points. In another example, a student can earn 50 points for each week in which they logged into the SIS every day to check their homework assignments. In a third example, a user can be rewarded with 200 points for completing an offer that was shown through the DAS.

In some embodiments, these points can be redeemable for coupons or discounts that will be made available to the user. In one example, a user can be shown a coupon for $1 off a combo meal at a local fast food restaurant upon reaching 500 points. In some embodiments, use of the coupon can further reward the user with additional points.

In some embodiments, users can choose which offer they receive after reaching a specified number of points. For example, a student with 300 points can have the choice to redeem a coupon for either $5 off a new pair of shoes or 10% off a game of laser tag in exchange for the 300 points. Furthermore, the student can elect to save the 300 points in hopes of gaining 200 more and being able to select an offer from the 500 point category.

In some embodiments, users can combine points and use them together. In one embodiment, a mother allows her child to use 100 of her points along with 200 of the student's points to select a 300 point offer. In another embodiment, two student having 250 points each can combine their points to receive a coupon for a discounted soccer ball that requires 500 total points.

In some embodiments, the SIS can include a calendar compiled by the system showing important dates which can include but are not limited to dates on the syllabus, dates on files uploaded by the teacher, due dates for assignments, athletic events, school events, deal expiration dates, and “sponsored” events that companies pay to have included. The system can also place other events on the calendar based upon the user's interests. For example, someone who visits the websites for the Atlanta Braves frequently will have Braves games on their calendar.

Users can add their own events to this calendar. Furthermore, advertisers can target market based upon the events that users add. In one embodiment, a user puts down “Lunch with Jim” as an event next week on their calendar and receives a targeted advertisement for a lunch special at a local restaurant.

In another embodiment, the DAS allows businesses to push out personalized coupons to users when they enter a store or the area surrounding the store based upon GPS. For example, Jenny walks into a book store. The bookstore has an account set up with a DAS. The DAS realizes Jenny is in the store and then pushes out a personalized coupon to her on her smartphone. The coupon can be based upon her upcoming assignments, say a 10% off a book that her class will be reading next week in English. It can also be based upon her past purchases. If she purchased the first two books of a series in the past few months, the 10% off coupon can be for the third book of the series. They key features here are the DAS recognizes that the user is at the store and selects a specific coupon for the person based upon student and merchant data. The merchant can input several different coupons in the DAS and have it select the most relevant, or they can put a specified discount percentage that the DAS can turn into a coupon for any item based upon what a user is likely to buy. This application is not limited to the nature and or types of advertising and/or promotional offers which can be made available through the methods disclosed herein and/or the DAS.

In another embodiment, a sports equipment store owner, Jim, puts two different coupons into the DAS. One is for a discount on a pair of Nike running shoes and one is for a discount on Nike football cleats. When a football player enters the store, they will get the coupon for football cleats, and when a cross country runner enters the store they will get the coupon for the running shoes. A member of the crew team that enters the store, however, does not have a coupon created specifically for his sport. Instead, the DAS can process an inference that the running shoe coupon is most relevant to the members of the crew team and then push out that coupon to him.

In some embodiments, the system can use a survey to obtain additional data about the user. Some of the data can be related to a student's academic performance. Questions might ask students to rate their academic performance over the last term, indicate whether they will be advancing to the next grade the upcoming year, select which co-curricular activities they plan to participate in, and/or rate their performance in relation to their peers.

In some embodiments, advertisers can use data regarding the student's academic performance to select targeted advertisements to display to the user. A user who struggles in English might be displayed an English tutoring coupon. In an embodiment, the DAS can process student grade data.

In an embodiment, the DAS has predictive technology. In some embodiments, the DAS can select advertisements based upon various types of data including, but not limited to age, gender, grade, zip code, activities, performances, and sibling relationships.

In some embodiments, the system can automatically track the exact number of page views an advertisement or coupon receives, the exact demographic profile of the persons providing each and every page view (meaning it will know the proportions of males v females, 12^{th} graders v. 9^{th} graders, football players v. baseball players, students v parents etc., viewing each advertisement), it will also know the proportional likelihood of males v females, 12 graders v 9^{th} graders, football players v baseball players, students v parents etc., actually clicking on each advertisement and/or executing each coupon. An advertiser will know for what exactly they are paying. Thus, if they want to buy 100,000 page views and they want those page views to only be seen by JV and Varsity athletes and their parents than the system can meet such requirements.

Many modifications and other embodiments of the invention will come to mind to one skilled in the art to which this invention pertains having the benefit of the teachings presented in the foregoing descriptions and the associated drawings. For example, as will be understood by one skilled in the relevant field in light of this disclosure, the invention can take form in a variety of different mechanical and operational configurations. Therefore, it can be to be understood that the invention can be not to be limited to the specific embodiments disclosed and that the modifications and other embodiments are intended to be included within the scope of the appended exemplary concepts. Although specific terms are employed herein, they are used in a generic and descriptive sense only and not for the purposes of limitation.

This scope disclosure can be to be broadly construed. It is intended that this disclosure discloses equivalents, means, systems and methods to achieve the devices, activities and mechanical actions disclosed herein. For each element or mechanism disclosed, it is intended that this disclosure also encompass in its disclosure and teaches equivalents, means, systems and methods for practicing the many aspects, mechanisms and devices disclosed herein. Additionally, this disclosure regards a computer system and its many aspects, features and elements. Such a computer system can be dynamic in its use an operation, this disclosure can be intended to encompass the equivalents, means, systems and methods of the use of the tool and its many aspects consistent with the description and spirit of the operations and functions disclosed herein. The claims of this application are likewise to be broadly construed. The description of the inventions herein in their many and varied embodiments are exemplary in nature and, thus, variations that do not depart from the gist of the invention are intended to be within the scope of the invention. Such variations are not to be regarded as a departure from the spirit and scope of the invention.

The apparatus, methods, systems and embodiments disclosed herein can be applied to any organization. In an embodiment, the disclosure herein can be applied to organizations in which the members or those having an association with the organization have an interest in the organization raising money. In an embodiment, a closed, known, defined or well-defined organization and/or group can benefit from the embodiments disclosed herein. Churches are an embodiment of an organization which can use the embodiments disclosed herein. Charitable organizations, nonprofits, as well as public or private entities can also use the technology disclosed herein.

In an embodiment, the software and systems herein can assist schools to meet government data reporting for funding.

This scope disclosure is to be broadly construed. It is intended that this disclosure disclose equivalents, means, systems and methods to achieve the communications, products, software, apps, functions, devices, activities, electronics, computers, systems and mechanical actions disclosed herein. For each functionality, software, method, computation, or executable program code disclosed, it is intended that this disclosure also encompass in its disclosure and teaches equivalents, means, systems and methods for practicing the many aspects of the methods, means, apparatus and articles disclosed herein. Additionally, this disclosure regards DAS, SIS and other software, systems and products related thereto and its many and varied aspects, features and elements. Such a technology can be dynamic in its use an operation, this disclosure is intended to encompass the equivalents, means, systems and methods of the use of the disclosed technology and its many aspects consistent with the description and spirit of the operations and functions disclosed herein. The claims of this application are likewise to be broadly construed.

The description of the inventions herein in their many embodiments is merely exemplary in nature and, thus, variations that do not depart from the gist of the invention are intended to be within the scope of the invention. Such variations are not to be regarded as a departure from the spirit and scope of the invention.

1. A method executed on a computer for directed advertising, comprising the steps of:
providing a computer;
providing a device having a device location data;
providing said computer having a memory, a processing unit adapted to execute program executable code and said computer adapted to run a program executable code of a directed advertising system;
said directed advertising system adapted to process a data from a student information system;
providing to said memory a school selection criterion comprising a geographic criterion;
providing to said memory a school geographic data which is an attribute of a school;
said computer running a program executable code of a rule-based logic to determine whether said school geographic data satisfies said school selection criterion,
if said school geographic data satisfies said school selection criterion, then said computer executes program executable code identifying said school as a matching school;
providing to said memory a plurality of school data of said matching school from said student information system of said matching school;
said plurality of school data comprising a first student data retrieved from said student information system;
providing to said memory a first target market criterion;
said computer running a program executable code of a rule-based logic to determine whether said first student data satisfies said first target market criterion;
if said first student data satisfies said first target market criterion, then said computer executes program executable code identifying said student as a matching target candidate;
providing to said memory a second target market criterion;
providing a device data of said device of said matching target candidate; said device data comprising said device location data;
said computer running a program executable code of a rule-based logic to determine whether said device location data of said device of said matching target candidate satisfies said second target market criterion;
if said device location data satisfies said second target market criterion, then said computer executes program executable code identifying said device as a matching device;
said computer running a program executable code of a rule-based logic which identifies a matching device as a candidate device if the matching device is associated with a matching target candidate;
providing to said memory an advertising criterion,
providing to said memory a second student data from said student information system;
said computer running a program executable code of a rule-based logic to determine whether said second student data matches said advertising criterion,
if said second student data satisfies said advertising criterion, then said computer executes program executable code identifying said matching device as a target device;
said directed advertising system processing an advertising data to electronically communicate to a target device;
said directed advertising system running a program executable code electronically providing said advertising data to said target device.

2. A method executed on a computer for directed advertising according to claim 1, further comprising the step of providing the first student data and the second student data which are the same.

3. A method executed on a computer for directed advertising according to claim 1, further comprising the step of providing the first student data and the second student data which are different.

4. A method executed on a computer for directed advertising according to claim 1, further comprising the step of providing the first student data which is a student name and the second student data which is a student attribute.

5. A method executed on a computer for directed advertising according to claim 1, further comprising an advertising criterion which is a location criterion.

6. A method executed on a computer for directed advertising according to claim 1, further comprising an advertising criterion which has a location criterion and a date criterion.

7. A method executed on a computer for directed advertising according to claim 1, further comprising an advertising criterion which has a location criterion and a time criterion.

8. A method executed on a computer for directed advertising according to claim 1, further comprising an advertising criterion which has a location criterion, a date criterion and a time criterion.

9. A method executed on a computer for directed advertising according to claim 1, further comprising a device data which comprises a location data.

10. A method executed on a computer for directed advertising according to claim 1, further comprising a device data which comprises a device status data.

11. A method executed on a computer for directed advertising according to claim 1, further comprising the step of providing the first target market criterion and the second target market criterion which are the same.

12. A method executed on a computer for directed advertising according to claim 1, further comprising the step of providing the first target market criterion and the second target market criterion which are different.

13. A method executed on a computer for directed advertising according to claim 1, further comprising the step of providing the first target market criterion which comprises a location and the second target market criterion which comprises a student interest.

14. A directed advertising system, comprising:
a computer;
a device having a device location data;
said computer having a memory, a processing unit adapted to execute program executable code and said computer adapted to run a program executable code of a directed advertising system;
a student information system adapted to provide a data for processing by said directed advertising system;
said directed advertising system adapted to process a school selection criterion comprising a geographic criterion;
said student information system adapted to provide a school geographic data which is an attribute of a school for processing by said directed advertising system;
said directed advertising system executing a rule-based logic of said program executable code to determine whether said school geographic data satisfies said school selection criterion,
said directed advertising system adapted to execute program executable code identifying said school as a matching school if said school geographic data satisfies said school selection criterion;
said student information system adapted to provide a plurality of school data of said matching school;
said plurality of school data comprising a first student data retrieved from said student information system;
said directed advertising system adapted to process a first target market criterion, said first target market criterion comprising a geographic criterion;
said directed advertising system adapted to execute program executable code identifying said student as a matching target candidate if said first student data satisfies said first target market criterion;
said directed advertising system adapted to process a second target market criterion, said second target market criterion comprising a device location data;
said directed advertising system adapted to process a device data from a said device of said matching target candidate; said device data comprising said device location data;
said directed advertising system adapted to execute program executable code to identify said device as a matching device if said device location satisfies said second target market criterion;
said directed advertising system adapted to execute program executable code to identify a matching device as a candidate device if the matching device is associated with a matching target candidate;
said directed advertising system adapted to process an advertising criterion;
said directed advertising system adapted to process a second student data, said second student data retrieved from said student information system;
said directed advertising system adapted to execute program executable code to identifying said matching device as a target device if said second student data matches said advertising criterion;
said directed advertising system adapted to electronically communicate an advertising data to a target device;
said directed advertising system adapted to running a program executable code and electronically provide said advertising data to said target device.

15. A directed advertising system according to claim 14, wherein said directed advertising system is adapted to execute program executable code to identify said device as a matching device if said student data satisfies two or more target market criterion.

16. A directed advertising system according to claim 14, wherein said directed advertising system is adapted to execute program executable code to identify said device as a matching device if a time criterion is satisfied.

17. A directed advertising system according to claim 14, wherein said directed advertising system is adapted to execute program executable code to identify said device as a matching device if a student interest criterion is satisfied.

18. A computer software product, comprising:
computer executable software code adapted to execute rule-based logic and process data which provides data to a computer memory,
computer executable software code adapted to process data exchange with a device having a device location data;
the computer executable software code adapted to be processed at least in part by a processing unit adapted to execute computer program executable code;
the computer executable software code adapted to process a data from a student information system;
the computer executable software code adapted to process a school selection criterion comprising a geographic criterion;
the computer executable software code adapted to process a school geographic data which is an attribute of a school;
the computer executable software code adapted to execute a program executable code of a rule-based logic to determine whether said school geographic data satisfies said school selection criterion,
if said school geographic data satisfies said school selection criterion, then said the computer executable software code executes program executable code identifying said school as a matching school;
the computer executable software code adapted to process a plurality of school data of said matching school from said student information system of said matching school;
said plurality of school data comprising a first student data retrieved from said student information system;
the computer executable software code adapted to process a first target market criterion;
said computer executable software code adapted to execute a program executable code of a rule-based logic to determine whether said first student data satisfies said first target market criterion;
if said first student data satisfies said first target market criterion, then said computer executable software code executes program executable code identitfying said student as a matching target candidate;
the computer executable software code adapted to process a second target market criterion;
the computer executable software code adapted to process a device data of said a device of said matching target candidate: said device data comprising a said device location data;
said computer executable software code adapted to execute a program executable code of a rule-based logic to determine whether said device location data of said device of said matching target candidate satisfies said second target market criterion;
if said device location data satisfies said second target market criterion, then said computer executable software code executes program executable code identifying said device as a matching device;
said computer executable software code adapted to execute a program executable code of a rule-based logic which identifies a matching device as a candidate device if the matching device is associated with a matching target candidate;
the computer executable software code adapted to process an advertising criterion;
the computer executable software code adapted to process a second student data from said student information system;
said computer executable software code adapted to execute a program executable code of a rule-based logic to determine whether said second student data matches said advertising criterion;
if said second student data satisfies said advertising criterion, then said computer executable software code executes program executable code identifying said matching device as a target device;
said computer executable software code adapted to process an advertising data to electronically communicate to a target device;
said computer executable software code adapted to execute a program executable code electronically providing said advertising data to said target device.

19. A computer software product according to claim 18, wherein said computer software product is a directed advertising system software product.
